(19) United States
(12) Patent Application Publication
(10) Pub. No.: US 2026/0326587 A1
(43) Pub. Date: Oct. 22, 2026

(54) SYSTEMS AND METHODS OF ELECTRIC VEHICLE CHARGING

(71) Applicant: Estelle Ingenuity, Homewood, IL (US)

(72) Inventors: Stephen Estelle, Homewood, IL (US); Daniel Estelle, Chicago, IL (US)

(73) Assignee: Estelle Ingenuity, Homewood, IL (US)

(21) Appl. No.: 19/182,558

(22) Filed: Apr. 17, 2025

(51) Int. Cl. B60L 53/16; H01R 13/631; H01R 13/73; H01R 24/86; H01R 31/06

(52) U.S. Cl. CPC B60L 53/16; H01R 13/631; H01R 31/065; H01R 13/73; H01R 24/86

(57) ABSTRACT

An electric vehicle (EV) charging adapter configured to interface with an EV charging station charger. The EV charging adapter may be hardwired with the EV charging station or a charger of the charging station may plug into the adapter for powering the adapter that is then used to power an EV. Further, an automated charging system that autonomously detects and connects an EV charger to an EV by automatically aligning and plugging an EV charger. The EV charging adapter may be configured with sensors, such as image sensors, that are used to autonomously detect and connect to an electric vehicle. Additionally, a universal charging connector may be configured to connect to an EV charging port and interface with the electric vehicle charging adapter, where the universal charging connector may have a small enough profile to remain connected to the EV charging port during operation of the vehicle.

### TECHNICAL FIELD

The present disclosure relates generally to the field of electric vehicle charging. More specifically, the present disclosure relates to electric vehicle charging adapters, including systems for autonomously connecting electric vehicle charging adapters to electric vehicles for recharging rechargeable batteries thereof.

### BACKGROUND

Electric vehicles (EVs) have become much more viable in recent years as EV technology has improved. As EV technology has improved, different aspects of EVs have improved. However, charging stations for charging rechargeable batteries have remained fairly standard with the exception of becoming faster in recharging the rechargeable batteries of the EVs.

Electric vehicle (EV) charging stations connect to EV charging connectors. However, not all countries use the same charging connectors on their EVs. For example, EVs in the United States primarily use J1772 connectors, EVs in China primarily use GB/T connectors, and EVs in Europe primarily use Mennekes connectors. Further, AC and DC charging systems connect to different EV charging connectors. For example, AC charging ports include J1772 connectors and Mennekes connectors while DC charging ports include the combined charging system (CCS) connectors (type 1 and 2), CHAdeMO connectors, and GB/T connectors. In some cases, such as Tesla's Supercharger connector (also known as the North American Charging Standard (NACS)), which supports both AC and DC charging, the connector may be proprietary technology. Even as the charging standards in different countries become more standardized (e.g., most EVs in the United States will soon use the NACS), newer EVs, some of which have autonomous capabilities, use different charging standards.

Many EVs use connector adapters to connect EVs to EV charging stations when the EV and the EV charging station do not use the same connectors. However, these connector adapters typically only allow compatibility between two different charging connectors (e.g., J1772 connector and CCS connector). Additionally, these connector adapters are large and an EV charging customer must attach and detach the connector adapter from the EV during each EV charging session.

Electric vehicles have advanced to include autonomous electric vehicles (AEVs). Autonomous electric vehicles (AEVs) may be used for driverless taxis, driverless delivery services, and so on. However, many of these services occur in the metropolitan areas that are a considerable distance away from dedicated charging stations at which charging operators connect EV chargers to recharge the AEVs. Because of the considerable distance AEVs must travel to reach charging operators, the time spent by the AEVs traveling to the charging operators and traveling back to the metropolitan areas results in a significant loss of revenue for the operators of the AEV.

Currently, AEVs charge at a home base of the EV's original equipment manufacturer (OEM) instead of charging at an EV charging station during a travel session. This occurs for several reasons. First, unless the AEV has an operator that manually connects an EV charging station cable to an EV charging port, the AEV cannot autonomously charge at an EV charging station. Second, the EV charging station may not include connectors that are compatible with the charging port on the AEV. Accordingly, there is a need for a system that improves charging of EVs and AEVs to improve convenience and efficiency thereof.

### SUMMARY

To overcome the limitations of EV charging stations, such as legacy charging stations having charging ports and connectors that are not configurable with different connectors on EVs, the systems and methods provided herein provide for a universal charging connector that may be installed on a charging port of the EV so as to be able to receive power from the legacy charging stations and configurable with an adapter power cable electrically connected to an EV charge station. To improve efficiency and of AEVs, an automatic charging station may provide for autonomous alignment and connection of a charging connector using an adapter with existing charging stations may be provided. The adapter may support automatic alignment in three dimensions so that an AEV may position itself in proximate position relative to the charging station and an adapter to enable automatic charging connection via a charging port of the AEV (or EV driven by a human).

One embodiment of an adapter for connecting an electric vehicle charging station to an electric vehicle may include an input connector configured to (i) electrically connect to a charging connector of the electric vehicle charging station and (ii) receive one or more power signals and one or more data signals from the electric vehicle charging station. An output connector may be electrically connected to the input connector and be configured to electrically connect to a universal charging connector electrically connected to a charging port of the electric vehicle.

One embodiment of a system for autonomously detecting a charging port of an electric vehicle may include an actuator and an object detection system electrically connected to a first end of the actuator. The object detection system may be configured to locate the charging port. An input connector may be electrically connected to a second end of the actuator, where the input connector may be configured to receive an electric vehicle charging adapter. An output connector may be electrically connected to the first end of the actuator, where the output connector may be configured to electrically connect to the charging port.

One embodiment of a universal charging connector for an electric vehicle may include a housing configured to securely fit within an input connector of the electric vehicle. A first connector may be connected to a first end of the housing configured to electrically connect to the input connector of the electric vehicle may be used to recharge a rechargeable battery thereof. A second connector may be connected to a second end of the housing having a different configuration than the first connector. An electrical connector may be configured to electrically connect the first connector and the second connector, thereby enabling the electric vehicle to receive electrical power and data signals from an electric vehicle charging station.

### BRIEF DESCRIPTION OF THE DRAWINGS

FIG. 1 is an illustration depicting electric vehicles, electric vehicle chargers, and vehicle charging adapters, according to an embodiment of the disclosure;

FIG. 2A is a perspective view of an illustrative electric vehicle charging adapter including an assembly configured to autonomously detect and connect to a charging connector of an electric vehicle according to an embodiment of the disclosure;

FIG. 2B is a top-down view of an illustrative electric vehicle charging adapter including an assembly configured to autonomously detect and connect to a charging connector of an electric vehicle according to an embodiment of the disclosure;

FIG. 3A is a perspective view of an illustrative electric vehicle charging adapter including an assembly configured to autonomously detect and connect to a charging connector of an electric vehicle, where the electric vehicle charging adapter is electrically connected to an electric vehicle charging station according to an embodiment of the disclosure;

FIG. 3B is a perspective view of an illustrative electric vehicle charger of an electric vehicle charging station according to an embodiment of the disclosure;

FIG. 3C is a block diagram of an interface for an electric vehicle charging station according to an embodiment of the disclosure;

FIG. 4A is an outside view of an illustrative system configured to autonomously detect and connect to a charging connector of an electric vehicle in an extended arrangement according to an embodiment of the disclosure;

FIG. 4B is an outside view of an illustrative assembly configured to autonomously detect and connect to a charging connector of an electric vehicle in a collapsed arrangement according to an embodiment of the disclosure;

FIG. 4C is an inside view of an illustrative assembly configured to autonomously detect and connect to a charging connector of an electric vehicle in an extended arrangement according to an embodiment of the disclosure;

FIG. 4D is an inside view of an illustrative assembly configured to autonomously detect and connect to a charging connector of an electric vehicle in a collapsed arrangement according to an embodiment of the disclosure;

FIG. 4E is an inside view of an illustrative assembly configured to autonomously detect and connect to a charging connector of an electric vehicle in a collapsed arrangement according to an embodiment of the disclosure;

FIG. 4F is an inside view of an illustrative assembly configured to autonomously detect and connect to a charging connector of an electric vehicle in a collapsed arrangement according to an embodiment of the disclosure;

FIG. 4G is an inside view of an illustrative assembly configured to autonomously detect and connect to a charging connector of an electric vehicle in a collapsed arrangement according to an embodiment of the disclosure;

FIG. 5 is a detailed diagram of an adapter-based charging system for charging an electric vehicle according to an embodiment of the disclosure;

FIG. 6A is a flow diagram of an illustrative method for charging an electric vehicle according to an embodiment of the disclosure

FIG. 6B is a flow diagram of an illustrative method for autonomously charging an electric vehicle using an autonomous charging assembly according to an embodiment of the disclosure.

FIG. 7 is a front view of an illustrative output connector configured for an electric vehicle charging adapter and/or an assembly configured to autonomously detect and connect to a charging connector of an electric vehicle according to an embodiment of the disclosure;

FIG. 8A is a front view of an illustrative universal charging connector configured for an electric vehicle according to an embodiment of the disclosure;

FIG. 8B is a perspective view of an illustrative universal charging connector system configured for an electric vehicle according to an embodiment of the disclosure;

FIG. 8C is a block diagram of an illustrative universal charging connector system for an electric vehicle according to an embodiment of the disclosure;

FIG. 9A is a perspective view of an illustrative electric vehicle charging adapter in combination with a system for autonomously detecting and connecting to a charging connector of an electric vehicle according to an embodiment of the disclosure;

FIG. 9B is a side view of an illustrative electric vehicle charging adapter in combination with a system for autonomously detecting a charging connector of an electric vehicle according to an embodiment of the disclosure;

FIG. 10A shows an illustrative electric vehicle charging adapter in combination with a system for autonomously detecting and connecting to a charging connector in a collapsed arrangement beneath an electric vehicle according to an embodiment of the disclosure;

FIG. 10B shows an illustrative electric vehicle charging adapter in combination with a system for autonomously detecting and connecting to a charging connector in an extended arrangement beneath an electric vehicle according to an embodiment of the disclosure;

FIG. 11A shows an illustrative electric vehicle charging adapter in combination with a system for autonomously detecting and connecting to a charging connector in a collapsed arrangement beside an electric vehicle according to an embodiment of the disclosure;

FIG. 11B shows an illustrative electric vehicle charging adapter in combination with a system for autonomously detecting and connecting to a charging connector in an extended arrangement beside an electric vehicle according to an embodiment of the disclosure;

FIG. 12 shows an illustrative electric vehicle charging port without a universal charging connector according to an embodiment of the disclosure.

### DETAILED DESCRIPTION

Generally, the embodiments disclosed herein are directed to electric vehicle charging. The disclosed embodiments may include an electric vehicle charging adapter configured to interface with an electric vehicle charging station charger. Further, the disclosed embodiments may include an automated charging system that autonomously detects and connects to an electric vehicle, where the electric vehicle charging adapter may include the system for autonomously detecting and connecting to an electric vehicle. Additionally, the disclosed embodiments may include a universal charging connector configured to connect to an electric vehicle charging port and interface with the electric vehicle charging adapter.

TABLE 1 below depicts different aspects of EV charging stations and a universal EV charging adapter that mates to the universal charging connector, according to the implementations disclosed herein. In particular, the different aspects may include an EV charging adapter, an autonomous charging assembly, and/or a universal charging connector. The EV charging adapter may be powered by an EV charging station, either hard-wired, or enable a user to plug an OEM EV charger into the adapters and the EV charging adapter. The EV charging adapter may also include an adapter or connector different from the OEM EV charger that is configured to electrically connect an EV charging station to an EV charging port. In other words, the EV charging adapter expands the ability of an EV charging station to charge EVs using one connector to connect to two or more different connectors to support EVs with different connectors at their EV charging ports. The autonomous charging assembly may include a system configured to autonomously detect and connect to an EV charging port. The universal charging connector may include a housing configured to securely fit within an existing or OEM input connector of the electric vehicle and interface with EV charging adapters. A first configuration may include an EV charging adapter, but not an autonomous charging assembly and a universal charging connector. A second configuration may include an EV charging adapter and a universal charging connector, but not an autonomous charging assembly. A third configuration may include an EV charging adapter, an autonomous charging assembly, and a universal charging connector. A fourth configuration may include an EV charging adapter, an autonomous charging assembly, and a universal charging connector. It should be understood that the configurations are illustrative and that alternative configurations may be utilized in accordance with the principles described herein.

TABLE 1
Embodiments Configurations

| | Electric Vehicle | Autonomous | Universal Charging |
|---|---|---|---|
| Configuration | Charging Adapter | Charging Assembly | Connector |
| Manual Mode V1 | Yes | No | No |
| Manual Mode V2 | Yes | No | Yes |
| Autonomous Mode V1 | Yes | Yes | No |
| Autonomous Mode V2 | Yes | Yes | Yes |

### Charging an Electric Vehicle at an EV Charging Station

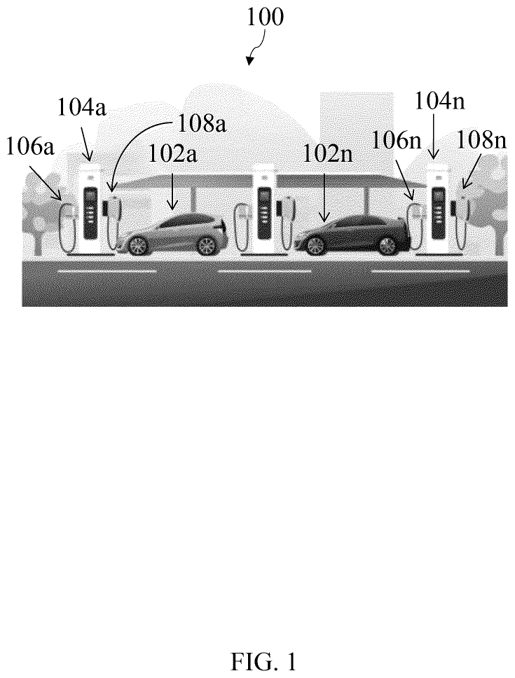

Referring to FIG. 1, a perspective view of a scenario 100 depicting an illustration of electric vehicles 102a-102n (collectively “electric vehicles 102”), electric vehicle charging stations 104a-104n (collectively “EV charging stations 104”), OEM electric vehicle chargers 106a-106n (collectively “OEM EV chargers 106”), and electric vehicle charging adapters 108a-108n (collectively “EV charging adapters 108”) is shown. Generally, scenario 100 may depict an EV charging scenario, where EV charging stations 104 may charge one or more of the electric vehicles 102 parked at and/or near EV charging stations 104.

Electric vehicles 102 may refer to any EV configured to charge at EV charging stations 104. For example, electric vehicles 102 may include battery electric vehicles, plug-in hybrid electric vehicles, hybrid electric vehicles, fuel cell electric vehicles, extended-range electric vehicles, kinetic energy storage vehicles, or any other type of electric vehicle configured to charge at the EV charging station 104. Electric vehicles 102 may also include charging port(s). In some embodiments, electric vehicles 102 may have the same configuration of charging ports or different configurations of charging ports. For example, electric vehicles 102 may include EVs with GB/T charging ports, Mennekes charging ports, CCS charging ports (type 1 and 2), CHAdeMO charging ports, Tesla's charging ports, or any other charging port. The charging port(s) on electric vehicles 102 may interface with OEM EV chargers 106 and/or EV charging adapters 108 to enable charging thereby.

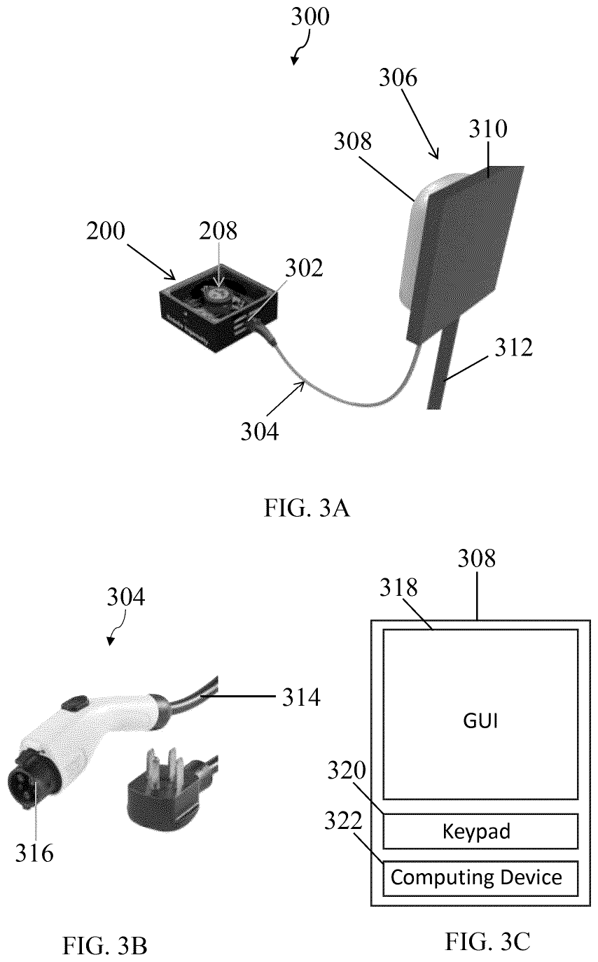

EV charging stations 104 may include OEM EV chargers 106 and EV charging adapters 108. Generally, EV charging stations 104 may include charging configuration(s). For example, EV charging stations 104 may support slow charging, fast charging, and/or DC fast charging. EV charging stations 104 may charge electric vehicles 102 via OEM EV chargers 106 and/or EV charging adapters 108. OEM EV chargers 106 may include cable(s) (see, for example, cable 314 in FIG. 3B) connected to EV charging stations 104 and connector(s) (see, for example, output connector 316 in FIG. 3B) configured to interface with corresponding OEM EVs. For example, OEM EV chargers 106 may include Tesla® Superchargers with Tesla® charging connectors configured to interface with charging ports of Tesla® EVs. Further, OEM EV chargers 106 may include manual changers. For example, OEM EV chargers 106 may be configured for a user to physically connect OEM EV chargers 106 to electric vehicles 102. Further, EV charging adapters 108 may include adapter housings configured to be mounted to EV charging stations 104. In some embodiments, EV charging adapters 108 may be configured to physically and/or electrically connect with the connector(s) of OEM EV chargers 106, thereby powering the EV charging adapters 108. EV charging adapters 108 may include output connector(s) configured to interface with charging ports of EV(s). Power may flow from EV charging stations 104 to EV charging adapters 108 via OEM EV chargers 106 and EV charging adapters 108 may electrically conduct the power received from EV charging stations 104 to electric vehicles 102. In some embodiments, the output connector(s) are different from the connector(s) of OEM EV chargers 106. For example, the OEM EV chargers 106 may include Tesla® EVs charging connectors, but EV charging adapters 108 may include J1772 charging connectors. With such a configuration, Tesla Superchargers may connect to EV charging adapters 108 to charge non-Tesla EVs. In some embodiments, EV charging adapters 108 may be autonomous charging assemblies configured to autonomously detect and connect to EV charging ports of electric vehicles 102, as further described herein.

### Autonomous Charging Assembly

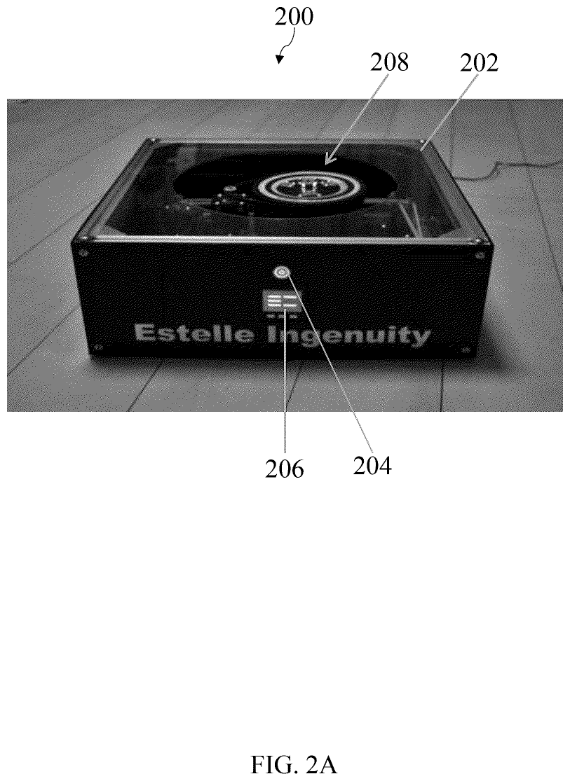

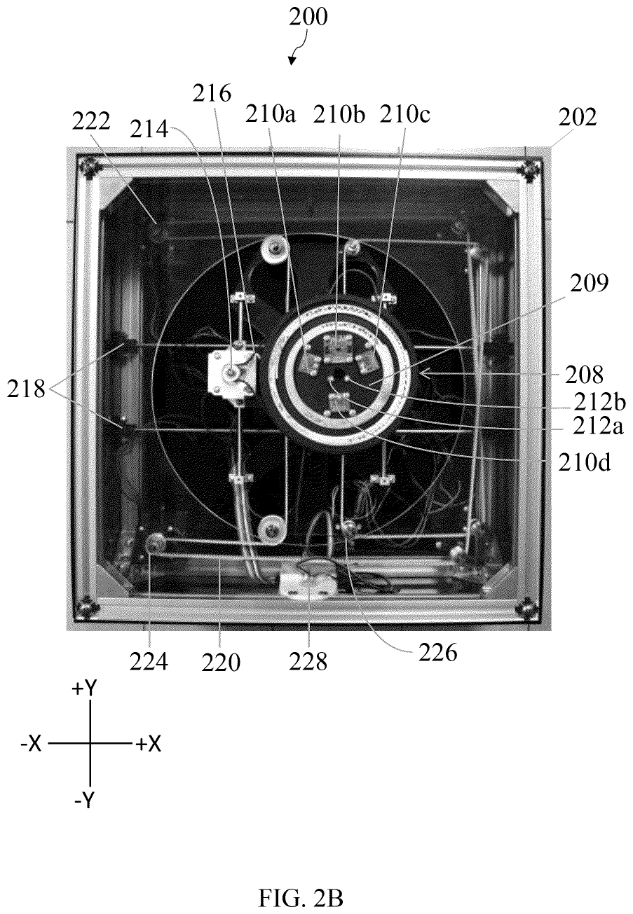

Referring now to FIGS. 2A-2B, perspective views of an illustrative electric vehicle charging adapter including an assembly configured to autonomously detect and connect to a charging connector of an electric vehicle is shown according to an embodiment of the disclosure. EV charging adapter 200 may include housing 202, power button 204, control panel 206, and autonomous charging assembly 208.

Housing 202 may refer to any structure configured to house electrical component(s). Housing 202 may include metals (e.g., aluminum, steel, cooper, etc.), plastics and composites (e.g., acrylonitrile, polycarbonate, fiberglass reinforced plastic, etc.), specialty materials (e.g., carbon fiber composites, ceramic and glass, rubberized and silicone coatings, etc.), or any other materials that provide durability, heat resistance, and/or electromagnetic shielding. Housing 202 may house or otherwise partially enclose autonomous charging assembly 208. Housing 202 may include a square structure, a rectangular structure, or any other structure shape configured to contain autonomous charging assembly 208. Housing 202 may include port(s) configured to receive signals (e.g., data signals, electrical power signals, etc.) of any communication protocol corresponding to system(s). For example, housing 202 may include a power port (see, for example, adapter input connector 302 in FIG. 3A) configured to interface with a charging connector of an EV charger to receive power from an EV charging station (see, for example, FIG. 1).

Housing 202 may include power button 204 and control panel 206. Power button 204 and control panel 206 may be accessible from side(s) of housing 202. For example, housing 202 may include power button 204 and control panel 206 on at least one of an inside side of housing 202 or an outside side of housing 202. In some embodiments, power button 204 and control panel 206 are available on a third-party device, such as a remote control, a smartphone (e.g., a smartphone mobile application), a computer (e.g., a computer web application), or any other third-party device configured to include power button 204 and/or control panel 206. Power button 204 may be connected to (e.g., electrically connected to or wirelessly connected to) electronics included in housing 202.

Power button 204 and control panel 206 may correspond with electrical component(s) (e.g., processors, controllers, power regulators, driver(s), etc.) contained in housing 202. Power button 204 may activate and/or deactivate the electronics included in housing 202. For example, power button 204 may activate and/or deactivate autonomous charging assembly 208. Similarly, control panel 206 may be connected to (e.g., electrically connected to or wirelessly connected to) the electronics included in housing 202. Control panel 206 may control features or functions of the electronics included in housing 202. In some embodiments, control panel 206 may receive inputs and display information via a user interface (e.g., a graphical user interface, a menu-driven interface, a touch-based interface, etc.). For example, control panel 206 may be configured to receive and/or display the charging rate (e.g., slow, medium, fast), the type of charging (e.g., DC charging, AC charging, etc.), the charging duration, payment methods (e.g., credit card, mobile payment, etc.), and so on. Further, control panel 206 may provide proof of purchase (e.g., a receipt) upon receiving a transaction request from a user (e.g., a request to charge an EV and the required payment) upon processing the transaction request.

Housing 202 may contain, house, or otherwise include autonomous charging assembly 208, which may include any system configured to autonomously connect to EV charging ports. Autonomous charging assembly 208 may include a combination of electrical components, mechanical components, and/or electrotechnical components that cause autonomous charging assembly 208 to connect to EV charging ports, as discussed herein.

Referring to FIG. 2B, autonomous charging assembly 208 may include sensors 210a-210c (collectively “sensors 210”) and output connector 212. Sensors 210 may refer to any sensors configured to detect the position or configuration of an EV charging port. Side(s) of autonomous charging assembly 208 may include sensors 210. For example, sensors 210 may be positioned along a top surface 209 of autonomous charging assembly 208. Further, sensors 210 may also be configured on the surface(s) to facilitate detection of an EV charging port. For example, sensors 210 may be configured to point towards an EV charging port. Sensors 210 may include color sensors, vision sensors (e.g., cameras), proximity sensors (e.g., ultrasonic sensors, infrared sensors, etc.), magnetic field sensors (e.g., Hall Effect sensors), light detection and ranging sensors (LiDAR), radar sensors, pressure and/or weight sensors, alignment and/or docketing sensors, environmental sensors (e.g., temperature sensors, humidity and/or weather sensors), internal vehicle sensors (e.g., battery management sensors, orientation sensors, etc.), and any other type of sensor configured to detect the position or configuration of an EV charging port. In some embodiments, sensors 210 may include light emitting diode(s) (LEDs) to enhance image sensing. Sensors 210 may receive data type(s). For example, sensors 210 may receive environmental data (e.g., temperature, humidity, pressure, etc.), motion or positional data (e.g., acceleration, rotation/orientation, proximity, etc.), optical or imaging data (e.g., light intensity, color, infrared, thermal, lidar, etc.), acoustic or vibrational data, electrical or magnetic data (e.g., voltage, current, capacitance, inductance, etc.), tactile or force data (e.g., pressure, force, strain, torque, stress, etc.). In some embodiments, sensors 210 may store the received data in memory. Although FIG. 2B shows four sensors 210, it should be appreciated that sensors 210 may include more or fewer than the number of sensors shown in FIG. 2B.

Housing 202 may support terminals 212a and 212b (collectively output connector 212), which may include any connector configured to couple to, interface with, or otherwise connect to an EV charging connector. Output connector 212 may include plugs, pins, pads, prongs, sockets, terminal strips, blocks, or a combination thereof. For example, output connector 212 may include single-channel connectors, multi-channel connectors, co-axial channels, composite connectors (e.g., connectors with power and signal channels) plug and socket connectors (e.g., two-prong/three-prong plugs), industrial connectors (e.g., twist lock connector, high-current connectors, etc.), quick-disconnect connectors (e.g., blade connectors, ring and fork connectors), modular connectors (e.g., RJ45 connectors, DIN connectors, etc.), high-frequency/high-voltage connectors, weatherproof and ruggedized connectors (e.g., IP-rated connectors, military-grade connectors, etc.), terminal blocks (e.g., screw terminals, spring-loaded terminals, etc.), wireless connectors (e.g., inductive pads, resonant coupling connectors, etc.), or a combination thereof. In some embodiments, output connector 212 may correspond to signal type(s). For example, output connector 212 may correspond to power signal(s) (e.g., AC power, DC power, high-voltage power, low-voltage power, etc.), data signal(s) (e.g., CAN bus, ethernet, etc.), ground signal(s), communication signal(s), (e.g., proximity pilot, control pilot, proprietary communication protocols, etc.), mixed signal(s) (e.g., power and data, integration communication and control, etc.), auxiliary signal(s) (e.g., signals that support vehicle-to-grid to plug-and-charge functionality), ground and/or neutral signal(s), and so on.

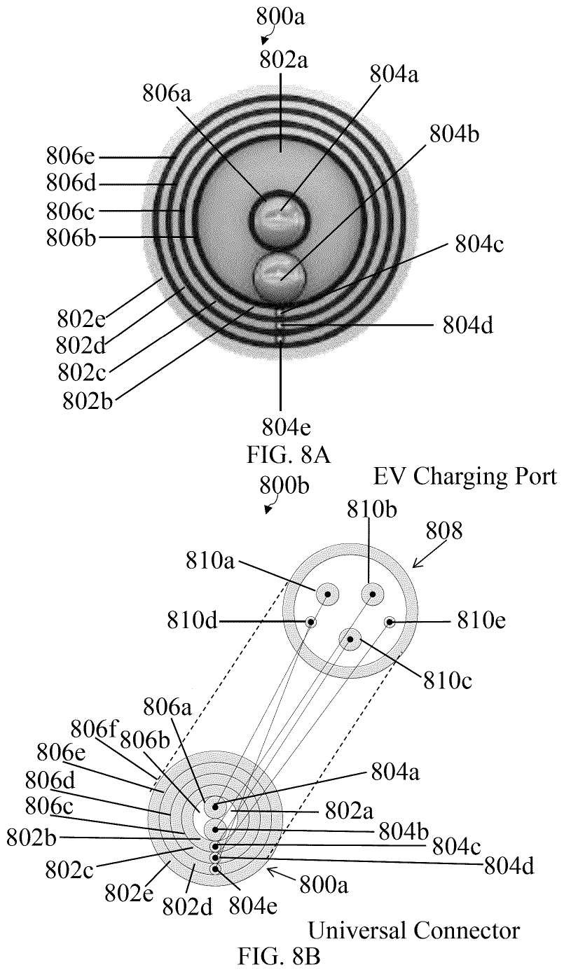

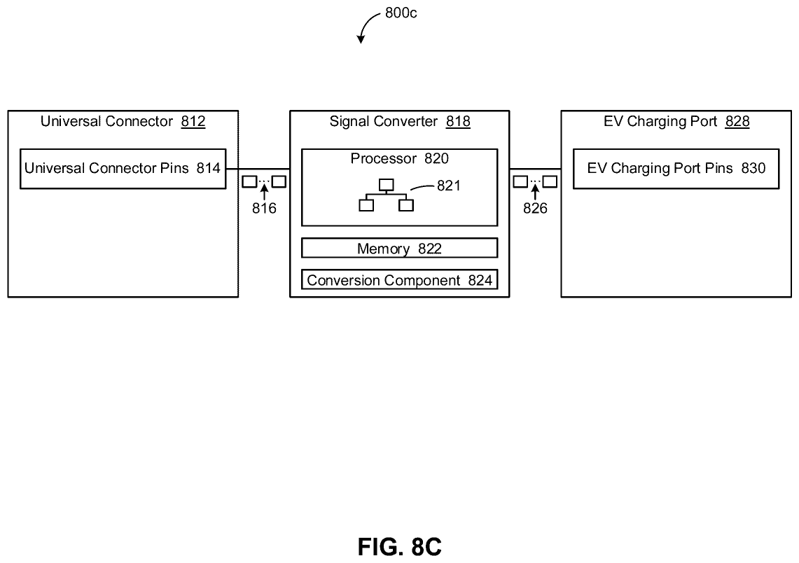

Output connector 212 may include configuration(s). In some embodiments, output connector 212 may include a configuration that is compatible with an EV charging port. For example, output connector 212 may include a configuration that is compatible with standard EV charging port connectors, such as J1772 charging ports, GB/T charging ports, Mennekes charging ports, CCS charging ports (type 1 and 2), CHAdeMO charging ports, Tesla charging ports, and more. In some embodiments, output connector 212 may include a configuration that is not compatible with an EV charging port. For example, output connector may include a J1772 connector interface and an EV charging port may include a CCS charging port. In some embodiments, output connector 212 may couple to, interface with, or otherwise connect to a universal charging connector (see, for example, FIGS. 8A and 8B) that allows output connector 212 to couple to, interface with, or otherwise connect to an otherwise incompatible EV charging port. In some embodiments, output connector 212 includes a secure locking mechanism such as a clip, retention member, or otherwise, to ensure a secure connection between output connector 212 and an EV charging port.

In some embodiments, output connector 212 may include a different configuration than charging connectors of EV charging stations 104. For example, charging connectors of EV charging stations 104 may include at a standard connector configuration (e.g., J1772, GB/T, Mennekes) while the universal charging connector includes a configuration that would not otherwise be compatible with each of the standard connector configurations. Further, the universal charging connector may contain fewer or greater power pins and/or data pins compared to the charging connector of the EV charging station, as further described herein.

Housing 202 may include component(s) for moving autonomous charging assembly 208 throughout housing 202. Housing 202 may include rotational motor 214, rotational belt 216, rails 218, belt 220, first motor 222, second motor 224, third motor 226, and switch terminal 228. In some embodiments, belt 220, first motor 222, second motor 224, and third motor 226 are arranged using configuration(s). For example, belt 220, first motor 222, second motor 224, and third motor 226 may be arranged using to a crossed belt configuration (e.g., a configuration where two belts intersect), a dial belt gantry system (e.g., a configuration where two belts are synchronized on a Cartesian or CoreXY frame), an H-belt configuration (e.g., a looped belt configuration in a H-pattern), a polar belt configuration (e.g., a configuration where two belts are circular), or a stacked belt configuration (e.g., a configuration where two belts operate at different heights), a single belt configuration (e.g., a configuration with one belt), or a combination thereof. It should be understood that alternative electrotechnical configurations that do not include belts may be utilized. Still yet, rather than using a cartesian coordinate system, a polar coordinate system may be utilized to control the positioning of autonomous charging assembly 208.

EV charging adapter 200 may include rotational motor 214 and rotational belt 216. Rotational motor 214 may couple or otherwise connect to rotational belt 216, where rotational motor 214 may cause rotational belt 216 to move. Further, rotational belt 216 may couple to or otherwise connect to a circumference of autonomous charging assembly 208. Rotational motor 214 may actuate causing autonomous charging assembly 208 to rotate in a clockwise direction or a counterclockwise direction so as to telescope outwards to inwards using the structural features thereof. It should be appreciated that EV charging adapter 200 may include more or less than the exemplary number of rotational motors shown in FIG. 2B.

EV charging adapter 200 may include belt 220, first motor 222, second motor 224, and third motor 226. First motor 222, second motor 224, and third motor 226 may connect to, may couple to, or otherwise connect to belt 220, where first motor 222, second motor 224, and third motor 226 may cause belt 220 to move. Further, belt 220 may couple to or otherwise connect to rails 218. In some embodiments, belt 220, first motor 222, second motor 224, and third motor 226 comprise a pulley system. In the pulley system, first motor 222, second motor 224, and third motor 226 may individually actuate or simultaneously actuate to move or linearly displace autonomous charging assembly 208 in a +x direction or a −x-direction along rails 218, to move or linearly displace rails 218 in a −y direction or a +y direction, or move or linearly displace autonomous charging assembly 208 and rails 218 in an x-y direction (e.g., +x/+y, +x/−y, −x/+y, −x/−y). It should be appreciated that EV charging adapter 200 may include more or fewer than the illustrative number of x-y motors shown in FIG. 2B.

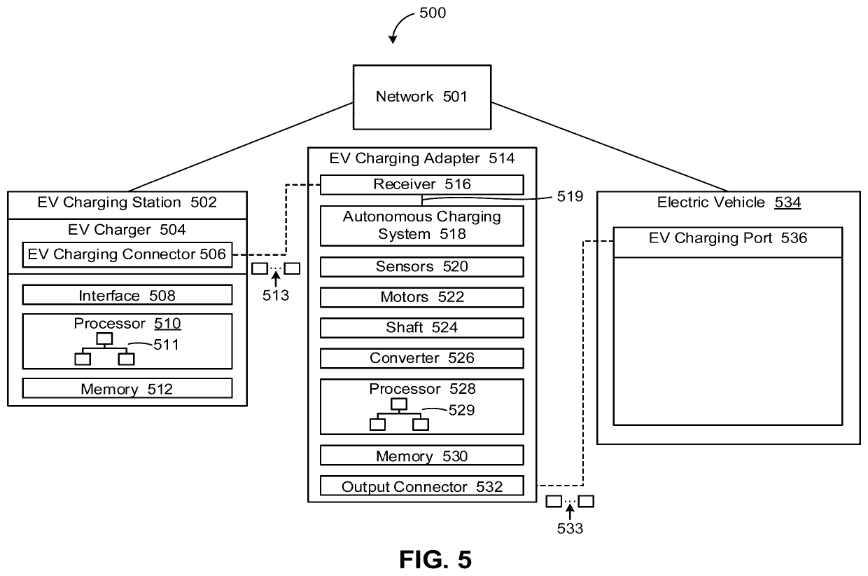

EV charging adapter 200 may include switch terminal 228, which may include circuitry and/or wiring corresponding to power button 204 and/or control panel 206. In some embodiments, switch terminal 228 may include a power button control circuit. Pressing power button 204 may cause switch terminal 228 to transmit a signal to processors or power management integrated circuits (see FIG. 5, for example). In some cases, a debounce circuit may eliminate noise in the signal generated in response to pressing power button 204. The power management integrated circuit may activate a MOSFET or relay based on the signal to turn on power to the electrical components in EV charging adapter 200. In some embodiments, switch terminal 228 may include a capacitive touch control circuit. The capacitive touch control circuit may detect physical inputs (e.g., touching contact) and convert the physical inputs into electrical signals. Processors may process the electrical signals and cause responses in the electrical component(s) in EV charging adapter 200. For example, processors may control the charging configuration (e.g., DC charging, AC charging, DC fast charging, etc.) of autonomous charging assembly 208 based on the physical or remote-control inputs received by control panel 206.

Referring now to FIG. 3A, a perspective view of an illustrative electric vehicle charging adapter including an autonomous charging assembly 208 configured to autonomously detect and connect to a charging connector of an electric vehicle, where the electric vehicle charging adapter is electrically connected to an EV charging station 306, is shown according to an embodiment of the disclosure. Charging system 300 may include EV charging adapter 200, where EV charging adapter may include autonomous charging assembly 208 and adapter input connector 302. Charging system 300 may further include EV charger 304 and EV charging station 306, where EV charging station 306 may include interface 308, backboard 310, and post 312.

Charging system 300 may include adapter input connector 302, which may include an electrical connector configured to receive EV charger 304 and the electrical power provided by EV charger 304. EV charger 304 may include cable 314 and output connector 316 as shown in FIG. 3B, where cable 314 may connect to EV charging station 306. Adapter input connector 302 may be attached to side(s) of EV charging adapter 200. For example, adapter input connector 302 may be attached to a front side of EV charging adapter 200. Adapter input connector 302 may include a configuration that is compatible with the output connector on EV charger 304. For example, adapter input connector 302 may include a configuration that is compatible with standard EV connectors, such as J1772 charging ports, GB/T charging ports, Mennekes charging ports, CCS charging ports (type 1 and 2), CHAdeMO charging ports, Tesla charging ports, and more. In some embodiments, adapter input connector 302 includes a secure locking mechanism, such as a clip, retention member, or otherwise, to ensure a stable connection between the adapter input connector 302 and EV charger 304.

Charging system 300 may include EV charging station 306, which may include a charging station configured to provide electrical power to EVs. EV charging station 306 may include interface 308, which may include computing system(s) configured to receive input(s) corresponding to EV charging. Interface 308 may be mounted on backboard 310, where backboard 310 may connect to post 312. Alternative structures may be utilized to support the interface 308. In some embodiments, interface 308 may include user interface(s) configured to receive input(s) from EV charging customers. For example, interface 308 may include graphical user interface 318 (also referred to as a GUI) and/or keypad 320, as shown in FIG. 3C, where graphical user interface 318 and/or keypad 320 may be configured to receive a charging request to charge an electric vehicle, a charging configuration (e.g., AC charging, DC charging, fast charging, slow charging, etc.), a payment method, and any other user inputs corresponding to EV charging. In some embodiments, interface 308 may include computing system(s) configured to receive wireless input(s) from electric vehicles 102. For example, interface 308 may include computing device 322, where computing device 322 may be configured to wirelessly receive a charging request to charge electric vehicles 102. The charging request may include a charging configuration, a payment method, an EV identification number, and any other information pertinent to EV charging.

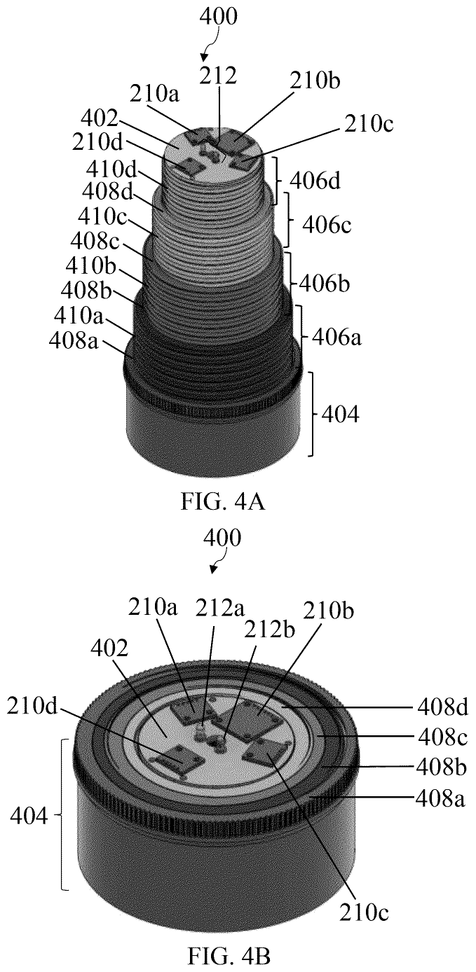

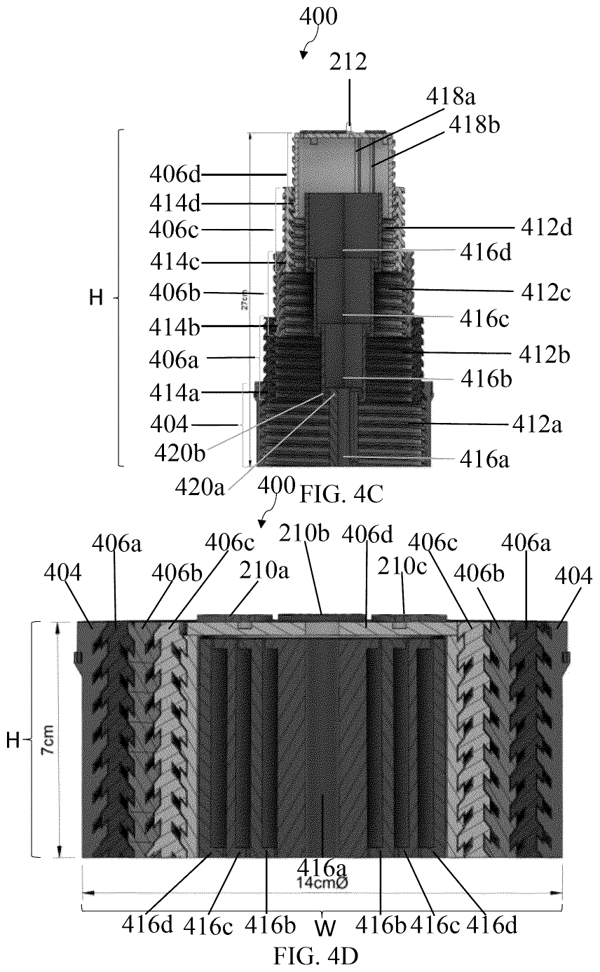

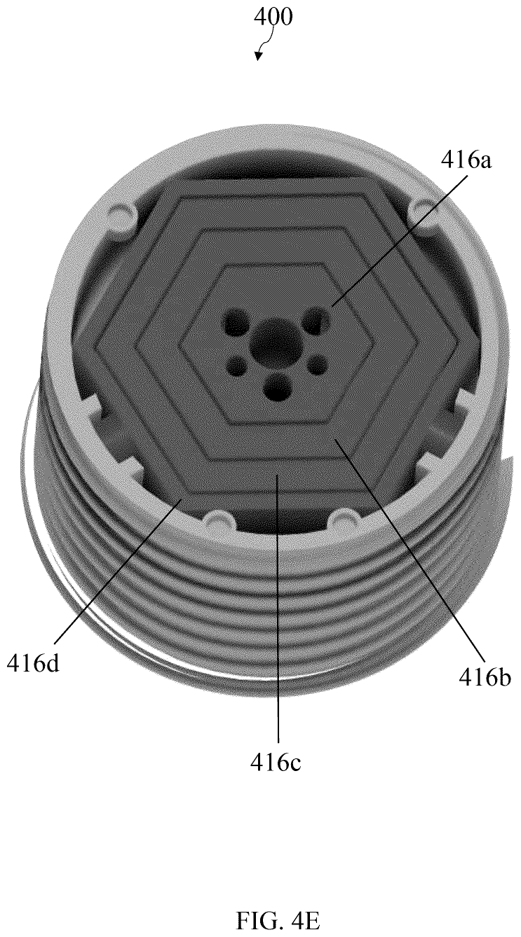

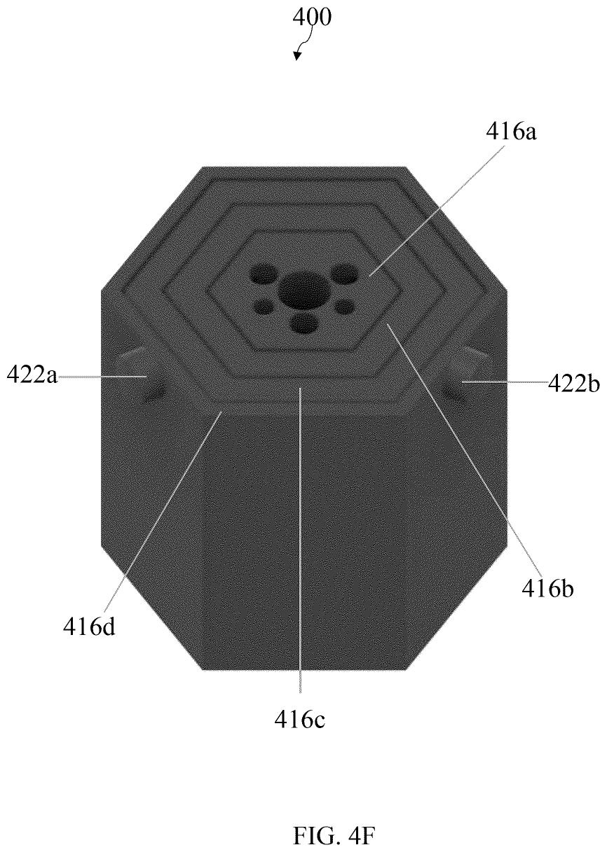

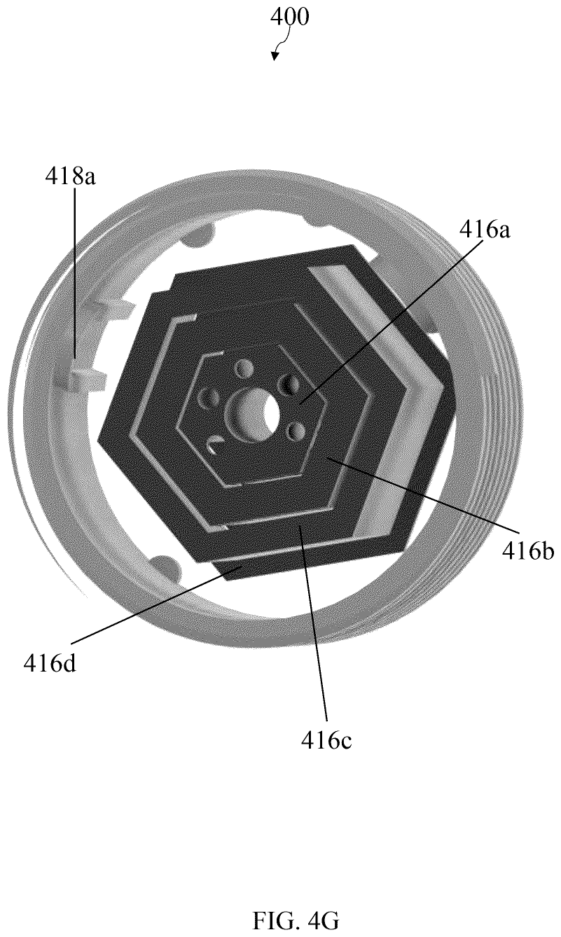

Referring now to FIGS. 4A-4D, inside and outside views of an illustrative autonomous charging assembly 400 configured to autonomously detect and connect to a charging connector of an electric vehicle are shown in respective extended and collapsed arrangements according to embodiments of the disclosure. Autonomous charging assembly 400 may include top surface 402, sensors 210a-210d (collectively “sensors 210”), output connector 212, base 404, intermediary bases 406a-406d (collectively “intermediary bases 406”), base edges 408a-408d (collectively “base edges 408”), external base grooves 410a-410d (collectively “external base grooves 410”), internal base grooves 412a-412d (collectively “internal base grooves 412”), touchpoints 414a-414d (collectively “touchpoints 414”), inner bases 416a-416d (collectively “inner bases 416”), guide rails 418a-418b (collectively “guide rails 418”), structural features 420a-420b (collectively “structural features 420”), and stops 422a-422b (collectively “stops 422”).

In some embodiments, top surface 402 may include sensors 210 and output connector 212. For example, sensors 210 and output connector 212 may be connected to an upper surface of top surface 402. Sensors 210 may be arranged on the top surface 402 such that sensors 210 may determine a distance between the top surface 402 and an EV charging port and/or a configuration of an EV charging port. For example, sensors 210 may be arranged around a circumference of the top surface 402 such that sensors 210 may detect an EV charging port when autonomous charging assembly 400 extends and contracts. Further, output connector 212 may be arranged on the top surface 402 such that output connector 212 may couple to, interface with, or otherwise connect to an EV charging port. For example, output connector 212 may be connected to a center portion of the top surface 402 such that output connector may couple to, interface with, or otherwise electrically connect to an EV charging port without interfering with sensors 210. Alternative configurations for aligning and electrically connecting output connector 212 and an EV charging port are contemplated.

Autonomous charging assembly 400 may include base 404, intermediary bases 406, base edges 408, external base grooves 410, and internal base grooves 412. Base 404 may refer to a structural base of autonomous charging assembly 400 and intermediary bases may refer to substructures of autonomous charging assembly 400. In some embodiments, base 404 and intermediary bases 406a-406c may include a center portion opening. Base 404 and intermediary bases 406a-406c may contain or otherwise include base(s) within the center portion opening. For example, base 404 and intermediary bases 406 may form a nesting arrangement where base 404 may contain intermediary base 406a, intermediary base 406a may contain intermediary base 406b, intermediary base 406b may contain intermediary base 406c, and intermediary base 406c may contain intermediary base 406d. Further, external base grooves 410 and internal base grooves 412 may refer to interlocking grooves (e.g., V-shaped grooves, curved grooves, etc.). In some embodiments, base 404 and intermediary bases 406 may link with base(s) via external base grooves 410 and internal base grooves 412. For example, internal base groove 412a of base 404 may link with external base groove 410a of intermediary bases 406a at touchpoints 414a, internal base groove 412b of intermediary bases 406a may link with external base groove 410b of intermediary bases 406b at touchpoints 414b, internal base groove 412c of intermediary bases 406b may link with external base groove 410c of intermediary bases 406c at touchpoints 414c, and internal base groove 412d of intermediary bases 406c may link with external base groove 410d of intermediary bases 406d at touchpoints 414d. While the embodiment of base 404 and intermediary bases 406 shows circular bases, it should be appreciated that base 404 and intermediary bases 406 may include square bases, rectangular bases, triangular bases, and any other base configuration that facilitate autonomous EV charging. In some embodiments, external base grooves 410 and internal base grooves 412 may be threads for enabling telescoping action when spun relative to one another.

Autonomous charging assembly 400 may include inner bases 416, which may include bases embedded in autonomous charging assembly 400 that provide structural support when autonomous charging assembly 400 extends and/or rotates (e.g., clockwise, counterclockwise, etc.). Inner bases 416 may include circular bases, square bases, triangular bases, hexagonal bases, or any other base shape suitable for extending and/or rotating autonomous charging assembly 400. In some embodiments, inner bases 416b-416d may include a respective center portion opening. As shown in FIG. 4E, inner bases 416b-416d may contain or otherwise include inner bases 416b-416d within the respective center portion opening. For example, inner bases 416 may form a telescopic arrangement and/or a nesting arrangement where inner base 416d may contain or encircle inner base 416c, inner base 416c may contain or encircle inner base 416b, and inner base 416b may contain or encircle inner base 416a. In some embodiments, inner base 416a may be a lead base in that the inner base 416d extends further than the other inner bases 416b-416d. Further, each of inner bases 416b-416d may scale or otherwise axially extend along an adjacent inner base. For example, inner base 416b may extend along inner base 416a, inner base 416c may extend along inner base 416b, and inner base 416d may extend along inner base 416c. In some embodiments, inner bases 416 may directly or indirectly connect to motor(s) (e.g., AC/DC motors, servo motors, stepper motors, torque motors, permanent magnetic motors, switched reluctance motors, gear motors, hallow shaft motors, homopolar motors, etc.) configured to rotate and/or move inner bases 416.

In some embodiments, moving base 404 may cause autonomous charging assembly 400 to extend up or down. Rotating base 404 in a first direction may cause intermediary bases 406 to rotate and propel upwards, thus causing inner bases 416 to extend upward. In some embodiments, base 404 may rotate at a first speed until output connector 212 reaches a certain distance from an EV charging port, and then base 404 may begin to rotate at second speed, the second speed being slower than the first speed. Inner bases 416 may extend upward or downward based on a threading interaction between inner bases 416 and intermediary bases 406. As inner bases 416 extend upward, structural features of inner bases 416, such as structural feature 420a and structural feature 420b, may interlock as shown in FIG. 4C. Interlocking inner bases 416 may cause intermediary bases 406 to rotate. As intermediary bases 406 rotate, intermediary base 406a may extend upward along internal base groove 412a, intermediary base 406b may extend upward along internal base groove 412b, intermediary base 406c may extend upward along internal base groove 412c, and intermediary base 406d may extend upward along internal base groove 412d. After autonomous charging assembly 400 is fully extended upward, rotating base 404 in a second direction, the second direction being opposite the first direction, may cause intermediary bases 406 to rotate and propel downward, thus causing inner bases 416 to extend downward. As inner bases 416 extend downward, structural features of inner bases 416, such as structural feature 420a and structural feature 420b, may decouple as shown in FIG. 4D. Decoupling inner bases 416 may cause some of intermediary bases 406a-406d to stop rotating. As intermediary bases 406 stop rotating, intermediary base 406d may extend downward along internal base groove 412d, intermediary base 406c may extend downward along internal base groove 412c, intermediary base 406b may extend downward along internal base groove 412c, and intermediary base 406a may extend downward along internal base groove 412a.

In some embodiments, rotating inner base 416a in a first direction or moving inner base 416a upward may cause inner bases 416b-416d to extend up to the point shown in FIGS. 4A and 4C. For example, rotating inner base 416a or moving inner base 416a upward may cause inner base 416b to rotate and/or extend up inner base 416a, rotating inner base 416b and/or moving inner base 416b upward may cause inner base 416c to rotate and/or extend up inner base 416b, and rotating inner base 416c and/or moving inner base 416c upward may cause inner base 416d to rotate and/or extend up inner base 416c. Rotating inner base 416a in a second direction, where the second direction may be opposite the first direction, and/or moving inner base 416a downward may cause inner bases 416 to compress or telescope down to the point shown in FIG. 4D. For example, rotating inner base 416a in a second direction and/or moving inner base 416a downward may cause inner base 416b to rotate and/or extend down inner base 416a, rotating inner base 416b and/or moving inner base 416b downward may cause inner base 416c to rotate and/or extend down inner base 416b, and rotating inner base 416c and/or moving inner base 416c downward may cause inner base 416d to rotate and/or extend down inner base 416c. Although shown as using inner bases, it should be understood that alternative extension and retraction mechanisms, such as worm gears, pneumatic cylinders, hydraulic cylinders, or otherwise may be utilized in place of the inner bases 416. In some embodiments, inner bases 416 may move and/or rotate according to the principles described in FIGS. 4A-4D.

Autonomous charging assembly 400 may contain or otherwise include guide rails 418. For example, guide rails 418 may extend along an inner surface of autonomous charging assembly 400 as shown in FIG. 4G. Guide rails 418 may extend from a first point in the inner surface proximate top surface 402 to a second point proximate a bottom surface of autonomous charging assembly 400. In some embodiments, the extension range of autonomous charging assembly 400 is limited by stops 422 as shown in FIG. 4F. Guide rails 418 may facilitate the support/movement of internal component(s) (e.g., bases) of autonomous charging assembly 400. For example, guide rails 418 may provide support to top surface 402 as autonomous charging assembly 400 compresses and/or extends. The guide rails 418 may be independent or formed as part of intermediary base 406d or otherwise. Bearings or other dynamic structural features (e.g., wheels) may be used to limit to prevent inner bases 416 from becoming stuck as each one moves along the guide rails 418 and/or relative to one another.

In some embodiments, autonomous charging assembly 400 may include electrical connectors. For example, electrical connectors may be embedded inside autonomous charging assembly 400. The electrical connectors may transmit signals (e.g., data signals, power signals, etc.) through autonomous charging assembly 400. For example, electrical connectors may transfer signals received from EV charging station 306 to output connector 212, for example. In another example, electrical connectors may transfer transformed electrical signals (e.g., signals transformed as part of a conversion process) to output connector 212. Further, the electrical connectors may compress and/or extend with intermediary bases 406 and inner bases 416. Additionally, the electrical connectors may extend from output connector 212 at top surface 402 to an input connector (not shown) at a bottom surface of autonomous charging assembly 400.

It should be appreciated that autonomous charging assembly 400 is not limited to the embodiments disclosed herein. Autonomous charging assembly 400 may be used in additional applications unrelated to electric vehicle charging. For example, autonomous charging assembly 400 may be modified to be used in medical applications, security applications, manufacturing applications, or any other suitable applications.

Referring now to FIG. 5, a detailed diagram of an adapter-based charging system for charging an electric vehicle is shown. Network environment 500 may include a network 501, an EV charging station 502, an EV charging adapter 514, and an electric vehicle 534. EV charging station 502 may include EV charger 504, EV charging connector 506, interface 508, processor 510, and memory 512. EV charging station 502 may generate EV charging station signals 513. EV charging adapter 514 may include receiver 516 and autonomous charging system 518. Autonomous charging system 518 may include sensors 520, motors 522, shaft 524, converter 526, processor 528, software 529, memory 530, and output connector 532. EV charging adapter 514 may generate EV signals 533. Electric vehicle 534 may include EV charging port 536. EV charging station 502 may connect to EV charging adapter 514 and EV charging adapter 514 may electrically connect to electric vehicle 534. In some embodiments, EV charging connector 506 of EV charger 504 may electrically connect to receiver 516 of autonomous charging system 518 and output connector 532 may communicatively connect to EV charging port 536 of electric vehicle 534. Accordingly, EV charging station 502 may electrically connect to electric vehicle 534 via EV charging adapter 514 to charge electric vehicle 534.

Network 501 may refer to any wireless or wired connection for facilitating communication between EV charging station 502, electric vehicle 534, and any other internal or external components. For example, the network 501 may include a hardwired connection (e.g., copper wire or fiber optics) or a wireless connection (e.g., wide area network (WAN), controller area network (MAY), local area network (LAN), or personal area network (PAN). The network 501 may facilitate communications in accordance with various communication protocols, such as Transmission Control Protocol and Internet Protocol (TCP/IP), User Datagram Protocol (UDP), or IEEE communication protocols. In one example, the network 501 may include wireless communications according to Bluetooth specification sets, or another standard or proprietary wireless communication protocol. In another example, the network 501 may also include communications over a cellular network, including, e.g., a GSM (Global System for Mobile Communications), CDMA (Code Division Multiple Access), EDGE (Enhanced Data for Global Evolution) network.

In some embodiments, network 501 may facilitate communication between EV charging station 502 and electric vehicle 534 in accordance with vehicle-to-infrastructure (V2I) communication protocol(s) that enable wireless communication between EV charging station 502 and electric vehicle 534. For example, electric vehicle 534 may communicate data unidirectionally and/or bidirectionally to EV charging station 502 over network 501 using a V2I communication protocol (e.g., open charge point protocol (OCPP), ISO 15118 protocol, etc.). Electric vehicle 534 may communicate data, including positional information (e.g., where the AEV may be located relative to the EV charging station), battery status and/or information (e.g., low battery, high battery, battery capacity, charging requirements, etc.), charging preferences (e.g., a requested charging level and/or delivery mode), authentication information (e.g., AEV credentials, payment information, etc.), EV status (e.g., issues with charging ports and/or battery health), scheduling information (e.g., whether an EV has priority for charging if it is part of a fleet), end-of-charge notifications, and so on. EV charging station 502 may communicate data inclusive of estimated charging time, station availability (e.g., whether there is an EV currently occupying an EV charging station), charging options (e.g., charging level and/or delivery mode), pricing information (e.g., cost per kWh, session fees, etc.), error notifications (e.g., electrical faults, compatibility issues, etc.), diagnostics information, and so on.

EV charging station 502 may include EV charger 504 and EV charging connector 506. EV charger 504 may connect to EV charging station 502. For example, EV charger 504 may be connected to a cable that connects to EV charging station 502. EV charging connector 506 may be a connector configured to interface with EV charging adapter 514. For example, EV charging connector 506 may include J1772 connectors, CCS connectors, Mennekes connectors, Tesla connectors, GB/T connectors, or any other connector configured to interface with EV charging adapter 514. Further, EV charging station 502 may generate EV charging station signals 513 and output EV charging station signals 513 via EV charging connector 506. EV charging station signals 513 may include AC power signals, DC power signals, ground signals, neutral signals, and communication signals. For example, EV charging station signals 513 may include control pilot signals, proximity pilot signals, AC signals (high or low), DC signals (high or low), neutral signals, protective earth signals, or any other signals corresponding with EV charging. Further, EV charging station signals 513 may correspond to AC/DC voltage/current levels, signal frequency ranges, charging modes (e.g., level 1 charging, level 2 charging, DC fast charging, etc.), and communication protocols.

EV charging station 502 may include interface 508, which may include computing system(s) configured to receive input(s) corresponding to EV charging. In some embodiments, interface 508 may include user interface(s) configured to receive input(s) from EV charging customers. For example, interface 508 may include graphical user interface(s) (see, for example, graphical user interface 318 in FIG. 3C) and/or keypad(s) (see, for example, keypad 320 in FIG. 3C) configured to receive a charging request to charge electric vehicle 232, a charging configuration (e.g., AC charging, DC charging, fast charging, slow charging, etc.), a payment method, and any other user inputs corresponding to EV charging. In some embodiments, interface 508 may include computing system(s) configured to receive wireless input(s) from electric vehicle 534. For example, interface 508 may include computing system(s) configured to wirelessly receive a charging request to charge electric vehicle 534. The charging request may include a charging configuration, a payment method, an EV identification number, and any other information pertinent to EV charging.

EV charging station 502 may include processor 510, which may include processor(s) configured to control electrical component(s) of EV charging station 502. In some embodiments, processor 510 may receive and process instruction(s) stored in memory 512 corresponding to a charging session. Processor 510 may execute software 511 to configure component(s) of EV charging station 502 based on the instruction(s). For example, processor 510 may execute software 511, where software 511 may cause EV charger to provide DC fast charging at 150 W until a battery of electric vehicle 534 is completely charged based on the charging request and cause EV charging station 502 to generate a signal indicating secure electrical connection between EV charging station 502 and electric vehicle 534.

EV charging adapter 514 may include receiver 516, which may include any system or interface configured to receive a connection from EV charging station 502 so that EV charging station 502 may provide electrical power to EV charging adapter 514, including components of EV charging adapter 514. Receiver 516 may connect EV charging station via EV charging connector 506 of EV charger 504. Receiver 516 may include configuration(s) to interface with EV charging connector 506. For example, receiver 516 may receive GB/T connectors, Mennekes connectors, CCS charging connectors (type 1 and 2), CHAdeMO connectors, Tesla's connectors, or any other EV connector. Receiver 516 may connect to autonomous charging system 518 via electrical connector 519 to provide electrical power to EV charging adapter 514, including components of EV charging adapter 514. The power provided by receiver 516 EV charging adapter may power 514 autonomous charging system and electrical component(s) of autonomous charging system 518, including sensors 520, motors 522, and processor 528. Further, autonomous charging system 518 may transfer unused electrical power received via receiver 516 to output connector 532 to power electric vehicle 534.

EV charging adapter 514 may include autonomous charging system 518, which may include any system or assembly configured to autonomously connect to EV charging port 536. Autonomous charging system 518 may include a combination of electrical components, mechanical components, electromechanical components and software components that cause autonomous charging system 518 may connect to EV charging port 536.

Autonomous charging system 518 may include sensors 520, which may include any sensors configured to detect the position or configuration of EV charging port 536. Sensors 520 may include color sensors, vision sensors (e.g., cameras), proximity sensors (e.g., ultrasonic sensors, infrared sensors, etc.), magnetic field sensors (e.g., Hall Effect sensors), light detection and ranging sensors (LiDAR), radar sensors, pressure and/or weight sensors, alignment and/or docketing sensors, environmental sensors (e.g., temperature sensors, humidity and/or weather sensors), internal vehicle sensors (e.g., battery management sensors, orientation sensors, etc.), and any other type of sensor configured to detect the position or configuration of an EV charging port. In some embodiments, sensors 520 may include light emitting diode(s) (LEDs) to enhance image sensing. Sensors 520 may receive data type(s). For example, sensors 520 may receive environmental data (e.g., temperature, humidity, pressure, etc.), motion or positional data (e.g., acceleration, rotation/orientation, proximity, etc.), optical or imaging data (e.g., light intensity, color, infrared, thermal, lidar, etc.), acoustic or vibrational data, electrical or magnetic data (e.g., voltage, current, capacitance, inductance, etc.), tactile or force data (e.g., pressure, force, strain, torque, stress, etc.). In some embodiments, sensors 520 may store the received data in memory 530.

Autonomous charging system 518 may include motors 522, which may include any systems or assemblies configured to facilitate the movement of autonomous charging assembly 208, for example. Motors 522 may include servo motors, stepper motors, brushless DC motors, linear actuators, DC gear motors, induction motors, switched reluctance motors, or any other motors configured to facilitate the movement of autonomous charging assembly 208. Further, motors 522 may be configured to facilitate rotational movements or linear movements. For example, one or more motors 522 may rotate autonomous charging system 518 and one or more motors 522 may move autonomous charging assembly 208 in an x-direction, a y-direction, or a z-direction.

Autonomous charging system 518 may include shaft 524, which may include any structural body of autonomous charging system 518. In some embodiments, shaft 524 may include a telescopic shaft or a telescopic actuator. The telescopic shaft or the telescopic actuator may include multiple support shells or bases with multiple diameters arranged in a nesting arrangement. The innermost shell of the telescopic shaft or the telescopic actuator may include a top surface. The top surface may include sensors 520 and output connector 532. In some embodiments, motors 522 may cause shaft 524 to extend or contract. For example, sensors 520 may determine a position and configuration of an EV charging connector, sensors 520 may provide data corresponding to the position and configuration of the EV charging connector to a processor 528, and processor 528 may execute software 529 to cause one or more of motors 522 to actuate based on the data causing shaft 524 to extend and/or rotate such that output connector 532 interfaces with EV charging port 536.

Autonomous charging system 518 may output EV signals 533 at output connector 532. EV signals 533 may include AC power signals, DC power signals, ground signals, neutral signals, and communication signals that are the same as or different from signal(s) of EV charging station signals 513. In one example, EV signals 533 may include same or different control pilot signals, same or different proximity pilot signals, same or different AC signals (high or low), same or different DC signals (high or low), same or different neutral signals, and same or different protective earth signals. In another example, EV signals 533 may correspond to same or different AC/DC voltage/current levels, same or different signal frequency ranges, same or different charging types (e.g., level 1 charging, level 2 charging, DC fast charging, etc.), and same or different communication protocols.

Autonomous charging system 518 may include converter 526, which may include a conversion system configured to convert EV charging station signals 513 into EV signals 533 that are compatible with electric vehicle 534. Converter 526 may include system(s) for handling electronic signal conversion, including power converters, signal processing systems, voltage/current control circuits and any other systems for handling electronic signal conversion. In some embodiments, converter 526 may include a processor-based converter. Converter 526 may handle signal conversions between standard connector configurations, including J1772 connectors, CCS connectors, Mennekes connectors, Tesla connectors, GB/T connectors, or any other connector. For example, converter 526 may handle conversions between different control signals, including 1 kHz pulse width modulation (PWM) signals, ISO 15118 power line communication signals, and CAN bus signals. Further, converter 526 may determine that at least a portion of the electrical signals do not utilize conversion. If converter 526 determines that the conversion is not performed, converter 526 may route the compatible electrical signals EV charging station signals 513 to electric vehicle 534. In some aspects, converter 526 may translate communication protocols. For example, converter 526 may identify communication protocols corresponding to each of EV charging station 502 and electric vehicle 534, such as CAN bus, power line communication, open charge point protocol, or any other charging communication protocol, and execute a protocol translation based on the communication protocols of EV charging station 502 and electric vehicle 534. The translation may ensure that EV charging station 502 and electric vehicle 534 understand the same charging parameters, such as the vehicle ID, the charging status, the current/voltage requirements, and any other charging parameters.

Autonomous charging system 518 may include processor 528, which may include processor(s) configured to control electrical component(s) of autonomous charging system 518. Processor 528 may include digital signal processors (DSPs), application processors (APs), field programmable gate arrays (FPGAs), graphical processing units (GPUs), microcontrollers, communication processors, and any other processors that support the operation of autonomous charging system 518. In some embodiments, the processors correspond to electrical component(s) of autonomous charging system 518. For example, autonomous charging system 518 may include image processor(s) that correspond to sensors 520. Further, processor 528 may execute software 529, where software 529 may include computer vision software or any other type of imaging software (e.g., convolutional neural networks, software corresponding to Edge AI, software corresponding to 3D vision, and/or generative models, etc.), control algorithm software (e.g., PID control, Kalman filters, simultaneous localization and mapping, etc.) for detecting the position of EV charging connector, software for calculating a distance between output connector 532 and EV charging port 536, software for charting a travel path for shaft 524, and software for correcting errors in the travel path.

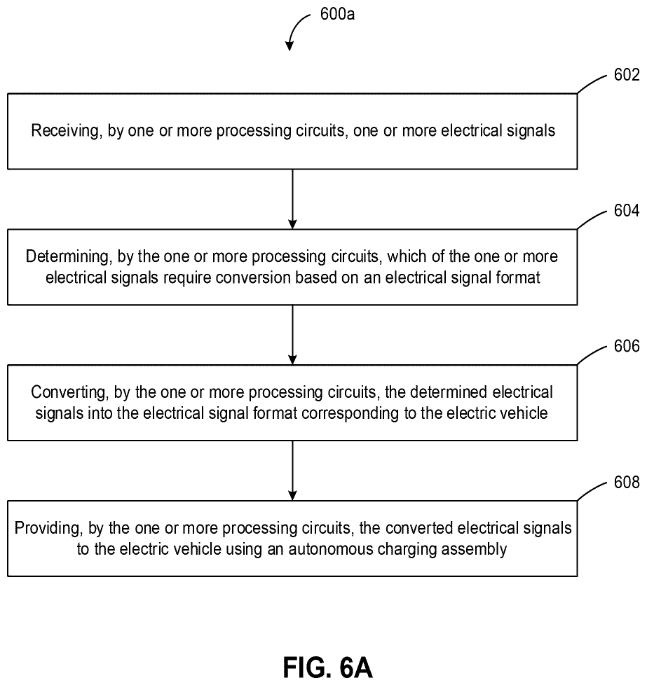

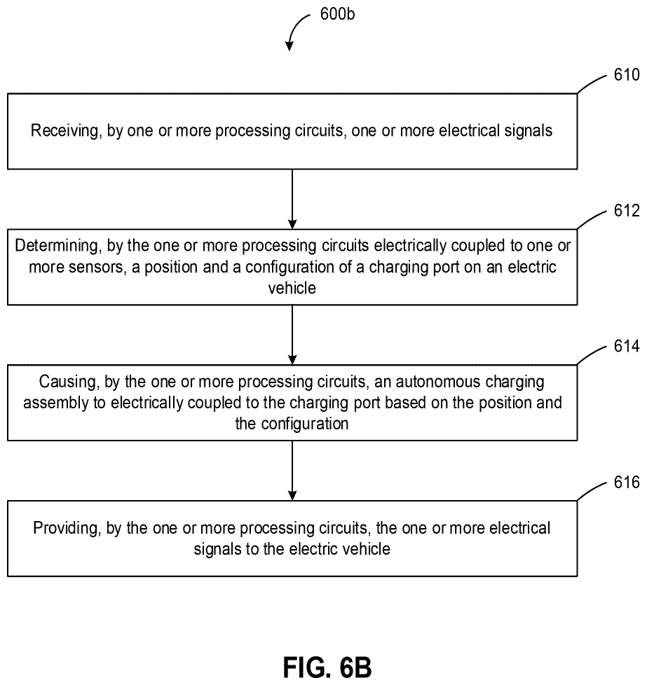

Referring now to FIG. 6A, a flow diagram of an illustrative method 600a for charging electric vehicle is shown. Method 600a may include receiving, from an electrical vehicle charging station, electrical signal(s) at step 602, determining, by processing circuit(s), which of the electrical signal(s) utilize conversion based on an electrical signal format corresponding to an electric vehicle at step 604, converting, by processing circuit(s), the determined electrical signals into the electrical signal format corresponding to an electric vehicle at step 606, and providing the converted electrical signals to the electric vehicle using an autonomous charging assembly. The operations of method 600a may correspond to executable instructions in software 529, converter 526, processor 528, or a combination thereof may execute method 600a.

At step 602, method 600a may include receiving, by processing circuit(s), electrical signal(s). The electrical signal(s) may correspond to an electric vehicle charging station. For example, EV charging station 502 may provide the electrical signal(s) to processing circuit(s) corresponding to autonomous charging system 518. The electrical signal(s) may include AC power signals, DC power signals, ground signals, neutral signals, communication signals, instructional data, informational data, metadata, or a combination thereof.

At step 604, method 600a may include determining, by processing circuit(s), which of the electrical signal(s) utilize conversion based on an electrical signal format corresponding to an electric vehicle. The electrical signal format may include the electrical signal format or protocol for an EV charging port on an electric vehicle. For example, EV charging port 536 on electric vehicle 534 may include a Mennekes connector, where the Mennekes connector may include a first AC power signal corresponding to a first AC power, a second AC power signal corresponding to a second AC phase, a third AC power signal corresponding to a third AC phase, a neutral signal configured to balance an AC load and provide return current, a grounding signal configured to prevent electrical faults, a first control signal corresponding to a PWM signal operating at 1 kHz and 3-12V, and a second control signal configured to detect a connection between EV charging station 502 and electric vehicle 534.

At step 606, method 600a may include converting, by processing circuit(s), the determined electrical signals into the electrical signal format corresponding to an electric vehicle. In some embodiments, the processing circuit(s) may electrically communicate with converter 526 to convert the determined electrical signals into the electrical signal formal corresponding to the electric vehicle. For example, software 529 may include protocol translation software and processor 528 may execute software 529 causing converter 526 to perform the signal conversion on the electrical signal(s) of EV charging station 502. Converter 526 may translate communication signals (e.g., PWM signals, CAN bus signals, PLC signals, etc.) and adjust the AC/DC voltage/current (e.g., step up/down the AC/DC voltage/current). In some embodiments, the conversion performed by converter 526 may be based on a charging mode (e.g., DC fast charging, AC charging, etc.). In an embodiment, the converter 526 is a fully hardware solution. Alternatively, the converter 526 may include firmware integrated with the hardware.

At step 608, method 600a may include providing the converted electrical signals to the electric vehicle using an autonomous charging assembly. Providing the converted electrical signals to the electric vehicle may include processor 528 executing software 529 to perform method 600b.

Referring now to FIG. 6B, a flow diagram of an illustrative method 600b for autonomously charging an electric vehicle using an autonomous charging assembly is shown. Method 600b may include receiving, by processing circuit(s), electrical signal(s) at step 610, determining, by the processing circuit(s) electrically coupled to sensor(s), a position and a configuration of a charging port on an electric vehicle at step 612, causing, by the processing circuit(s), the autonomous charging assembly to electrically connect to the charging port based on the position and the configuration at step 614, and providing, by the processing circuit(s), the electrical signal(s) to the electric vehicle at step 616. In some embodiments, method 600b may be a continuation of method 600a. For example, processor 528 may execute software 529 to perform method 600b responsive to completion of method 600a. In some embodiments, method 600b may be separate from method 600a. For example, processor 528 may execute software 529 to perform method 600b independent of method 600a. The operations of method 600b may correspond to executable instructions in software 529.

At step 610, method 600b may include receiving, by processing circuit(s), electrical signal(s) at step 610. The electrical signal(s) may correspond to an electric vehicle charging station. For example, EV charging station 502 may provide the electrical signal(s) to processing circuit(s) corresponding to autonomous charging system 518. The electrical signal(s) may include AC power signals, DC power signals, ground signals, neutral signals, communication signals, instruction data, informational data, metadata, or a combination thereof. Further, the electrical signal(s) may include converted electrical signals. For example, the electrical signal(s) may include the converted electrical signals generated in method 600a. The converted electrical signals may be based on an electrical signal format corresponding to an electric vehicle.

At step 612, method 600b may include determining, by the processing circuit(s) electrically coupled to sensor(s), a position and a configuration of a charging port on an electric vehicle at step 612. In some embodiments, the sensor(s) may provide data that the processing circuit(s) may use. For example, sensors 520 may collect data corresponding to a distance from sensors 520 to EV charging port 536 and/or a configuration of EV charging port 536, and processor 528 may execute computer vision software or any other type of imaging software included to improve the determined position and the determined configuration of EV charging port 536 of electric vehicle 534. Executing imaging software may include processor 528 executing data processing software included in software 529 to process the data collected by the sensor(s). Further, executing imaging software may include processor 528 executing artificial intelligence algorithms included in software 529 to further improve the determined position and the determined configuration of EV charging port 536. Alternatively, processor 528 may execute an open loop or closed loop control algorithm to control motion of autonomous charging system 518.

At step 614, method 600b may include causing, by the processing circuit(s), the autonomous charging assembly to electrically connect to the charging port based on the position and the configuration. In some embodiments, the processing circuit(s) may electrically communicate with motor(s) connected to autonomous charging system 518 to cause autonomous charging system 518 to connect to EV charging port 536 of electric vehicle 534. For example, processor 528 may execute motor software included in software 529 that causes motors 522 connected to shaft 524 and motors 522 connected to a circumference of autonomous charging system 518 to actuate, where actuating motors 522 may cause shaft 524 to extend towards EV charging port 536 and shaft 524 to rotate in alignment with EV charging port 536 based on the position and the configuration of EV charging port 536. Processor 528 may control the speed of motors 522, the torque of motors 522, the rotation direction of motors 522, and many other features of motors 522.

At step 616, method 600b may include providing, by the processing circuit(s), the electrical signal(s) to the electric vehicle. In some embodiments, the processing circuit(s) may provide the electrical signals to the electric vehicle based on an electrical connection. For example, processor 528 may execute detection software included in software 529 to determine whether output connector 532 is electrically connected to EV charging port 536 of electric vehicle 534. Further, output connector 532 may be electrically isolated from EV charging port 536 even when output connector 532 first contacts EV charging port 536. For example, a switch between output connector 532 and EV charging port 536 may open, thereby electrically isolating output connector 532 from EV charging port 536. Processor 528 may cause the switch between output connector 532 and EV charging port 536 to close causing EV charging port 536 to receive the electrical signal(s) responsive to determining an electrical connection between output connector 532 and EV charging port 536.

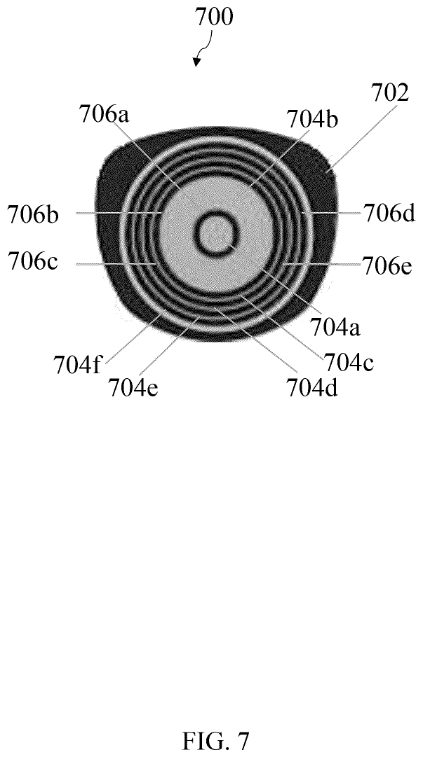

Referring now to FIG. 7, a front view of an illustrative output connector configured for an electric vehicle charging adapter and/or an assembly configured to autonomously detect and connect to a charging connector of an electric vehicle is shown according to an embodiment of the disclosure. Output connector 700 may include non-conductive structural member 702, electrodes 704a-704e (collectively “electrodes 704”), alignment feature 704f and electrode separators 706a-706e (collectively “electrode separators 706”). The combination of these elements may be referred to as the charging interface of output connector 700.

Output connector 700 may include non-conductive structural member 702, which may be a non-electrically conductive region of output connector 700. In some embodiments, non-conductive structural member 702 may include insulative material to discharge electrical signals (see, for example, EV signals 533) that fall outside electrodes 704. For example, non-conductive structural member 702 may include fixed inductors (e.g., air-core inductors, iron-core inductors, ferrite-core inductors, etc.), variable inductors, toroidal inductors, chokes, multilayer inductors, film inductors, and any other insulative material suitable for discharging electrical signals that fall outside the electrode regions.

Output connector 700 may include electrodes 704, which may include region(s) configured to interface with universal charging connector 800a. In some embodiments, electrodes 704 are circular regions. Alternative shapes and/or configurations of electrodes 704 may be utilized to provide the same or similar functionality. Electrodes 704 may be bounded by electrode separators 706. Electrode separators 706 may include material to electrically isolate electrodes 704 from each other, such as insulators. In some embodiments, some of the electrodes 704 may provide or receive electrical signal(s) (e.g., power signals, data signals, etc. of EV signals 533). For example, electrode 704a may provide or receive to a first power signal (e.g., AC power line), electrode 704b may provide or receive to a second power signal (e.g., DC power line), electrode 704c may provide or receive to a first data signal (e.g., proximity pilot), electrode 704d may provide or receive to a second data signal (e.g., control pilot), and electrode 704e may provide or receive a ground/neutral signal. In some embodiments, alignment feature 704f may be magnetic and/or non-electrically conductive. Universal charging connector 800a may include safety features to separate electrically conductive regions from non-electrically conductive regions. For example, an interface material, such as an insulator, may separate alignment feature 802e, which may be non-electrically conductive, from electrode 802d, which may be electrically conductive. In some embodiments, output connector 700 may include features to facilitate a mechanical connection between output connector 700 and universal charging connector 800a. For example, output connector 700 may include a grooved protrusion along alignment feature 704f configured to interface with a grooved indentation along alignment feature 802e of universal charging connector 800a.

In some embodiments, output connector 700 may contain signal pin(s) for each of electrodes 704 that may transmit corresponding electrical signals to a connector and/or a portion of a connector connected to the signal pin. The signals may be communicated in parallel and/or serially depending on the communication protocol. Further, the configuration of output connector 700 may help maintain an electrical connection between output connector 700 and universal charging connector 800a. For example, the output connector 700 can provide electrical signals to universal charging connector 800a or receive electrical signals from universal charging connector 800a regardless of how output connector 700 is oriented because of how the electrodes 704 are configured to receive or provide electrical signals.

In some embodiments, the charging interface of output connector 700 shown in FIG. 7 can be interchanged with the charging interface of universal charging connector 800a shown in FIGS. 8A and 8B.

### Universal Charging Connector

Referring now to FIG. 8A, a front view of a universal charging connector for an EV is shown according to an embodiment of the disclosure. Universal charging connector 800a may include electrodes 802a-802d (collectively “electrodes 802”), alignment feature 802e, output pin sockets 804a-804e (collectively “output pin sockets 804”), and electrode separators 806a-806e (collectively “electrode separators 806”). The combination of these elements may be referred to as the charging interface of universal charging connector 800a.

Universal charging connector 800a may include electrodes 802, which may include region(s) configured to interface with output connector 700. In some embodiments, electrodes 802 are circular regions. Alternative shapes and/or configurations of electrodes 802 may be utilized to provide the same or similar functionality. Electrodes 802 may be functionally equivalent to electrodes 704. For example, some of electrodes 802 may provide or receive corresponding electrical signals (e.g., power signals, data signals, etc. of EV signals 533) and each of electrodes 802 may be bounded by electrode separators 806. Electrode separators 806 may include material to electrically isolate electrodes 802 from each other, such as insulators In some embodiments, some of electrodes 802 may route the corresponding electrical signals to each of the output pin sockets 804 that correspond to electrodes 802. Further, electrodes 802 may include output pin sockets 804. Output pin sockets 804 may provide or receive electrical signal(s). For example, output pin socket 804a may provide or receive to a first power signal (e.g., AC power line), output pin socket 804b may provide or receive to a second power signal (e.g., DC power line), output pin socket 804c may provide or receive to a first data signal (e.g., proximity pilot), output pin socket 804d may provide or receive a second data signal (e.g., control pilot), and output pin socket 804e may provide or receive a ground/neutral signal. In some embodiments, universal charging connector 800a may be symmetric with output connector 700.

In some embodiments, output pin socket 804 may facilitate a connection with output connector 700. For example, output pin socket 804 may include magnetic connector(s), where the magnetic connector(s) may magnetically couple or otherwise magnetically connect with output connector 700. In some embodiments, alignment feature 802e may be magnetic and/or non-electrically conductive. Universal charging connector 800a may include safety features to separate electrically conductive regions from non-electrically conductive regions. For example, an interface material, such as an insulator, may separate alignment feature 802e, which may be non-electrically conductive, from electrode 802d, which may be electrically conductive. In some embodiments, universal charging connector 800a may include features to facilitate a mechanical connection between universal charging connector 800a and output connector 700 and universal charging connector 800a. For example, universal charging connector 800a may include a grooved protrusion along alignment feature 802e configured to interface with a grooved indentation along alignment feature 704f of output connector 700.

Output connector 700 may electrically couple or otherwise electrically connect with universal charging connector 800a. In some embodiments, output connector 700 electrically couples or otherwise electrically connects with universal charging connector 800a based on overlaps between corresponding electrode regions. For example, processor 528 may execute detection software included in software 529 to detect an overlap between electrode 704a and electrode 802a, and processor 528 may cause output connector 700 to transmit electrical signals (see, for example, EV signals 533) from electrode 704a to electrode 802a responsive to detecting the overlap. In some embodiments, the output connector 700 electrically couples or otherwise electrically connects with universal charging connector 800a based on electrical connections between pins and sockets. For example, processor 528 may execute electrical connection software included in software 529 to detect an electrical connection between signal pins on the output connector 700 and output pin sockets 804 on universal charging connector 800a, and processor 528 may cause output connector 700 to transmit electrical signals from the signal pins to the output pin sockets 804 responsive to detecting the electrical connection.

In some embodiments, determining the position and/or configuration of EV charging port 536 may include determining the position and/or configuration of electrodes 802 and/or output pin sockets 804. For example, processor 528 may execute computer vision software or any other imaging software included in software 529 to determine the shape/orientation of electrodes 802 and the output pin sockets 804 and the electrode separators 806 corresponding to the electrodes 802. Further, processor 528 may execute motor software included in software 529 that causes motors 522 to actuate such that electrodes 704 connect to or otherwise interface with output pin sockets 804 or electrode separators 806.

Referring now to FIG. 8B, a universal charging connector system is shown according to an embodiment described in the disclosure. Universal charging connector system 800b may include electrodes 802a-802d (collectively “electrodes 802”), alignment feature 802e, output pin sockets 804a-804e (collectively “output pin sockets 804”), electrode separators 806a-806f (collectively “electrode separators 806”), and EV charging port pins 810a-808e (collectively “EV charging port pins 810”) of EV connector 808.

In some embodiments, EV charging port pins 810 correspond to pin(s) on an EV charging port. For example, EV charging port pins 810 may represent the charging port pins on J1772 charging ports, GB/T charging ports, Mennekes charging ports, CCS charging ports (type 1 and 2), CHAdeMO charging ports, Tesla's charging ports, and any other EV charging port. EV charging port pins 810 may include less than or more than the number of pins shown in FIG. 8B based on the EV. In some embodiments, universal charging connector system 800b may transmit electrical signals (see, for example, EV signals 533) from output pin sockets 804 and/or electrodes 802 to EV charging port pins 810. For example, output pin sockets 804 and/or electrodes 802 may directly connect to EV charging port pins 810 via wires as shown in FIG. 8B to transmit electrical signals from output pin sockets 804 and/or electrodes 802 to EV charging port pins 810. In this arrangement, the electrical signals of output pin sockets 804 and/or electrodes 802 may directly correspond to the electrical signals of EV charging port pins 810 as shown in FIG. 8B.

In some embodiments, universal charging connector system 800b may include a housing configured to securely fit within an input connector of the electric vehicle. Generally, the housing may contain the same configuration as a corresponding charger capable of interfacing with the input connector. For example, an EV with a J1772 charging port may contain a housing that fits about or around the J1772 charging port, where the housing may contain the same or similar configuration as the J1772 charging port. In some embodiments, universal charging connector system 800b may interface with or otherwise connect to an electric vehicle. For example, universal charging connector system 800b may include a first connector (e.g., EV connector 808) connected to a first end of the housing configured to electrically connect to the input connector of the electric vehicle used to recharge a rechargeable battery thereof. In some embodiments, the universal charging connector system 800b may interface with or otherwise connect to an autonomous charging system or an autonomous charging assembly. For example, universal charging connector system 800b may include a second connector (e.g., universal charging connector 800a) connected to a second end of the housing having a different configuration than the first connector, where the second connector may connect with output connector 532 of autonomous charging system 518. In some embodiments, universal charging connector system 800b may include an electrical connector to electrically connect the first connector and the second connector, thereby enabling the electric vehicle to receive electrical power and data signals from an electric vehicle charging station.

In some embodiments, the charging interface of universal charging connector 800a shown in FIGS. 8A and 8B can be interchanged with the charging interface of output connector 700 shown in FIG. 7.

Referring now to FIG. 8C, a block diagram of a universal charging connector system is shown according to an example embodiment. Universal charging connector system 800c may include universal connector 812, signal converter 818, and EV charging port 828. Universal connector 812 may include universal connector pins 814. Signal converter 818 may include processor 820, software 821, memory 822, and conversion component 824. EV charging port 828 may include EV charging port pins 830.

Universal charging connector system 800c may include universal connector 812. In some embodiments, universal connector 812 may include universal charging connector 800a. Universal connector 812 may include universal connector pins 814. In some embodiments, universal connector pins 814 may include output pin sockets 804. Universal connector 812 may output universal connector signals 816 at universal connector pins 814. Universal connector signals 816 may include AC power signals, DC power signals, ground signals, neutral signals, and communication signals. For example, universal connector signals 816 may include control pilot signals, proximity pilot signals, AC signals (high or low), DC signals (high or low), neutral signals, protective earth signals, or any other signals corresponding with EV charging. Further, universal connector signals 816 may correspond to AC/DC voltage/current levels, signal frequency ranges, charging modes (e.g., level 1 charging, level 2 charging, DC fast charging, etc.), and communication protocols.

Universal charging connector system 800c may include signal converter 818, which may include computing system(s) configured to convert universal connector signals 816 into EV charging port signals 826. EV charging port signals 826 may include AC power signals, DC power signals, ground signals, neutral signals, and communication signals that are the same as or different from signal(s) of EV charging station signals universal connector signals 816. In one example, EV charging port signals 826 may include same or different control pilot signals, same or different proximity pilot signals, same or different AC signals (high or low), same or different DC signals (high or low), same or different neutral signals, and same or different protective earth signals. In another example, EV charging port signals 826 may correspond to same or different AC/DC voltage/current levels, same or signal frequency ranges, same or different charging types (e.g., level 1 charging, level 2 charging, DC fast charging, etc.), and same or different communication protocols.

Signal converter 818 may include conversion component 824, which may be the same as converter 526. For example, conversion component 824 may include the same components as converter 526, make the same determinations as converter 526, and perform the same conversion operations as converter 526. In some embodiments, conversion component 824 may fully or partially implement converter 526.

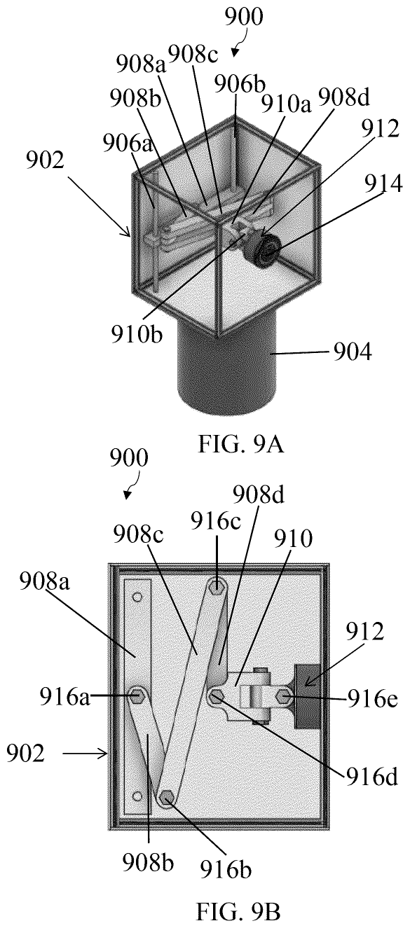

Referring now to FIGS. 9A and 9B, perspective views of an illustrative electric vehicle charging adapter in combination with a system for autonomously detecting and connecting to a charging connector are shown according to an example embodiment. EV charging system 900 may include housing 902, post 904, support beams 906a-906b (collectively “support beams 906”), and mechanical arm 907. Mechanical arm 907 may include base member 908a, connection members 908b-908d (collectively “connection members 908”), hinge 910, autonomous charging assembly 912, output connector 914, and screws 916a-916e (collectively “screws 916”).

EV charging system 900 may include housing 902. Housing 902 may be the same as housing 202. For example, housing 902 may include the same components as housing 202, and housing 902, similar to housing 202, may be configured to house electrical component(s). In some embodiments, housing 902 may be coupled or otherwise connected to post 904. Post 904 may be configured to increase a vertical height of housing 902. Post 904 may have a post height. The post height of post 904 may be based on a position of an EV charging port on electric vehicle(s). Further, the post 904 may be fixed or have a variable height control.

EV charging system 900 may include support beams 906. Support beams 906 may provide vertical support to mechanical arm 907 in housing 902. For example, support beams 906 may extend from an upper surface of housing 902 to a lower surface of housing 902 and mechanical arm 907 may couple or otherwise connect to the support beams 906. In some embodiments, mechanical arm 907 may vertically navigate along support beams 906. For example, a pulley system or any other system suitable for vertically moving objects along support beams 906 may adjust the vertical position of mechanical arm 907 along support beams 906.

EV charging system 900 may include mechanical arm 907. Mechanical arm 907 may include base member 908a, connection members 908, hinge 910, autonomous charging assembly 912, output connector 914, and screws 916. In some embodiments, base member 908a, connection members 908, hinge 910, autonomous charging assembly 912, output connector 914, and screws 916 may couple or otherwise connect together to form mechanical arm 907. For example, FIG. 9B may show an example configuration. Screw 916a may pivotably connect base member 908a to connection member 908b; screw 916b may pivotably connect connection member 908b to connection member 908c; screw 916c may pivotably connect connection member 908c to connection member 908d; screw 916d may pivotably connect connection member 908d to a first end of hinge 910 and screw 916e may pivotably connect hinge 910 to autonomous charging assembly 912, where the first end is opposite the second end.

In some embodiments, processor 528 may control movements of mechanical arm 907. For example, processor 528 may execute movement software included in software 529 to cause mechanical arm 907 to move according to degree(s) of freedom, but generally, three degrees of freedom for x-axis, y-axis, and z-axis motion control. Processor 528 may cause mechanical arm 907 to move vertically along support beams 906 such that autonomous charging assembly 912 may vertically align with EV charging port 536. Further, processor 528 may cause hinge 910 to vertically pan to facilitate further vertical alignment between autonomous charging assembly 912 and EV charging port 536. Processor 528 may also cause mechanical arm 907 to extend horizontally such that mechanical arm 907 may interface with or otherwise connect to EV charging port 536.

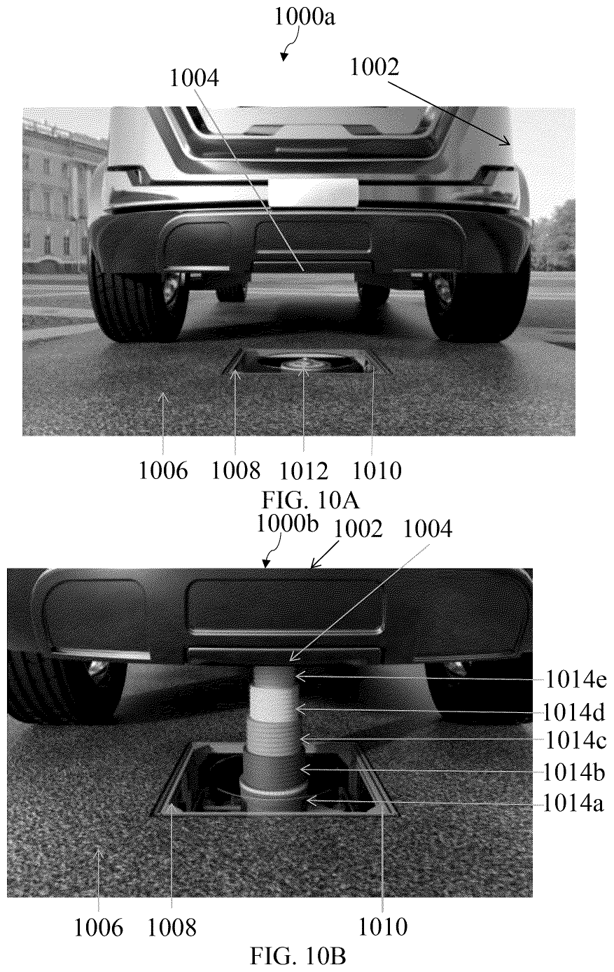

Referring now to FIG. 10A, an EV charging adapter in combination with a system for autonomously detecting a charging connector in a collapsed arrangement beneath an EV is shown according to an embodiment of the disclosure. Scenario 1000a may include electric vehicle 1002, EV charging port 1004, ground 1006, and EV charging adapter 1008. EV charging adapter 1008 may include housing 1010 and autonomous charging assembly 1012.

In some embodiments, scenario 1000a may be indicative of electric vehicle 1002 approaching autonomous charging assembly 1012 for a charging session. Electric vehicle 1002 may include EV charging port 1004, where EV charging port 1004 may be an EV charging port located at a bottom side of electric vehicle 1002. In some embodiments, EV charging port 1004 may include a universal charging connector described herein and the output connector on autonomous charging assembly 1012 may be configured to connect with the universal charging connector. Further, EV charging adapter 1008 may include housing 1010 and autonomous charging assembly 1012. Housing 1010 may contain or otherwise include autonomous charging assembly 1012. Both housing 1010 and autonomous charging assembly 1012 may be placed in a hole in ground 1006. In some embodiments, housing 1010 and/or autonomous charging assembly 1012 may receive power through underground cable(s) connected from power source(s). For example, the power source(s) may include EV charging stations, electrical substations, electrical power plants, and other power sources. Additionally, electric vehicle(s) may be positioned above autonomous charging assembly 1012 so that autonomous charging assembly 1012 may detect EV charging port 1004 and connect to EV charging port 1004 using the systems and methods described herein.

In some embodiments, housing 1010 and/or autonomous charging assembly 1012 may contain material(s), system(s), and/or component(s) to weatherproof EV charging adapter 1008. For example, housing 1010 and/or autonomous charging assembly 1012 may contain heating element(s) to ensure that ice and/or snow do not compromise the EV charging adapter 1008. In another example, housing 1010 may include weatherproof materials such as plastic or metal to help protect autonomous charging assembly 1012. In yet another example, electrical systems and/or components in housing 1010 and/or autonomous charging assembly 1012 may be coated in a waterproof coating and/or membranes (e.g., resin, acrylic, silicone, urethane) to protect the electrical systems and/or components.

In some embodiments, autonomous charging assembly 1012 may include an inductive output connector. For example, autonomous charging assembly 1012 may contain an inductive charging pad that provides electrical power to a receiver (e.g., EV charging port 1004) underneath electric vehicle 1002. The inductive charging pad may include a primary coil configured to receive AC and generate an alternative electromagnetic field responsive to receiving AC. Further, autonomous charging assembly 1012 may extend close to EV charging port 1004 so that EV charging port 1004 may capture the alternating magnetic field generated by the primary coil and the primary coil may induce an AC in electric vehicle 1002. Additionally, electrical system(s) in EV charging port 1004 may convert the AC into DC so that the EV may use the DC power to charge an EV battery. The inductive EV charging system (e.g., autonomous charging assembly 1012 with an inductive output connector) may be advantageous over inductive charging systems that rest on the ground or that are embedded into the ground because autonomous charging assembly 1012 may minimize the air gap. A larger air gap reduces the strength of the magnetic field generated when the primary coil receives AC. A smaller air gap allows for a stronger magnetic field, enabling higher power transfer rates, lower Eddy currents, and lower magnetic leakage.

Referring now to FIG. 10B, an EV charging adapter in combination with a system for autonomously detecting a charging connector in an extended arrangement beneath an electric vehicle according to an embodiment of the disclosure.

In some embodiments, autonomous charging assembly 1012 may include bases 1014a-1014e (collectively “bases 1014”). Bases 1014 may be arranged according to arrangement(s) described herein. For example, bases 1014 may extend from ground 1006 to EV charging port 1004 using of the systems or methods described herein such that an output connector of autonomous charging assembly 1012 may interface with or otherwise connect to EV charging port 1004.

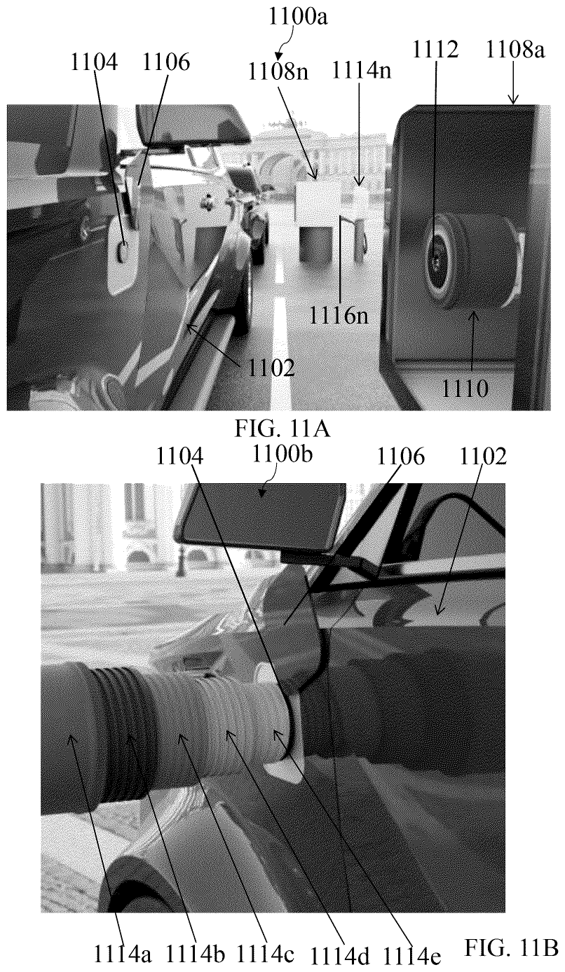

Referring now to FIG. 11A, an EV charging adapter in combination with a system for autonomously detecting a charging connector in a collapsed arrangement beside an EV is shown according to an embodiment of the disclosure. Scenario 1100a may include electric vehicle 1102, charging port 1104, door 1106, EV charging adapter 1108a, autonomous charging assembly 1110, output connector 1112, EV charging adapter 1108n, EV charging station 1114n, and EV charger 1116n.

In some embodiments, the systems and methods of autonomous alignment described in FIGS. 5 and 6B respectively are applicable to FIG. 11A.

Referring now to FIG. 11B, an EV charging adapter in combination with a system for autonomously detecting a charging connector in an extended arrangement beside an electric vehicle according to an embodiment of the disclosure. Scenario 1118 may include electric vehicle 1102, charging port 1104, door 1106, and bases 1114a-1114e (collectively “bases 1114”).

In some embodiments, the systems and methods of autonomous alignment described in FIGS. 5 and 6B respectively are applicable to FIG. 11B.

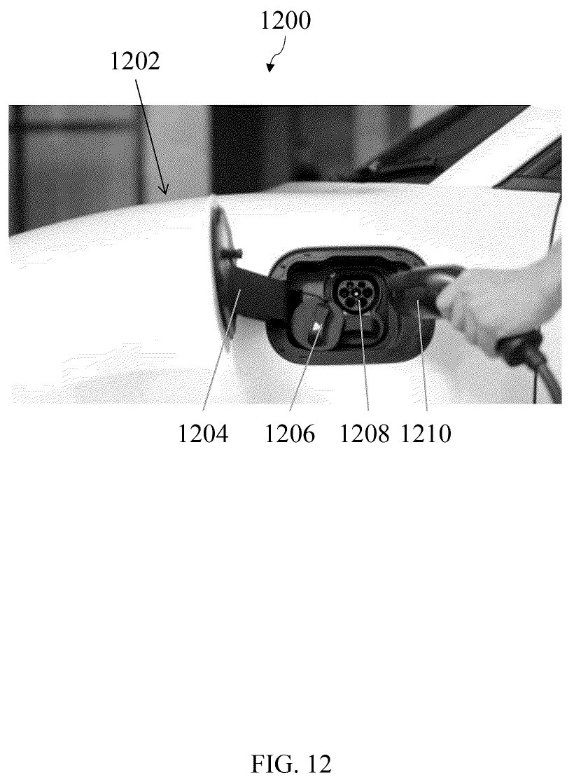

Referring now to FIG. 12, an electric vehicle charging port without a universal charging connector according to an embodiment of the disclosure. Scenario 1200 may include electric vehicle 1102, door 1204, cap 1206, EV charging port 1208, and charger 1210.

In some embodiments, universal charging connector 800a may fit onto EV charging port 1208 to enable cross-system compatibility. For example, output connector 700 may have a different configuration (e.g. different number and/or types of pins) than EV charging port 1208 and inserting universal charging connector 800a onto EV charging port 1208 may make EV charging port 1208 compatible with output connector 700. In some embodiments, universal charging connector 800a may replace cap 1206 that otherwise covers EV charging port 1208. Universal charging connector 800a may function as a connector configured to connect to EV charging port 1208 and as a cap that protects EV charging port 1208.

In some embodiments, the EV charging adapter 200 may include system(s) for removing cap 1206 and/or door 1204. In one example, autonomous charging assembly 208 may include magnet(s) that allow autonomous charging assembly 208 to pull open door 1204 on electric vehicle 1202. Alternatively, the door 1204 may be automatically opened in response to a control signal wirelessly communicated to the EV. In another example, autonomous charging assembly 208 may establish a connection between autonomous charging assembly 208 and electric vehicle 1202 using a V2I protocol and autonomous charging assembly 208 may transmit signal(s) to electric vehicle 1202 causing door 1204 to open. In yet another example, autonomous charging assembly 208 and/or an EV charging adapter 200 may contain robotic arm(s) that remove cap 1206 from EV charging port 1208.

The illustrations included herewith are not meant to be actual views of any particular systems, architecture, electronic or electrical hardware, or process, but are merely idealized representations that are employed to describe embodiments herein. Elements and features common between figures may retain the same numerical designation except that, for ease of following the description, for the most part, reference numerals begin with the number of the drawing on which the elements are introduced or most fully described. In addition, the elements illustrated in the figures are schematic in nature, and many details regarding the physical layout and construction of the systems (e.g., the EV charging adapter, the autonomous charging assembly, and the universal adapter) be described as they would be understood by those of ordinary skill in the art.

As used herein, the singular forms “a,” “an,” and “the” are intended to include the plural forms as well, unless the context clearly indicates otherwise.

As used herein, “or” includes any and all combinations of one or more of the associated listed items in both, the conjunctive and disjunctive senses. Any intended descriptions of the “exclusive-or” relationship will be specifically called out.

As used herein, the term “configured” refers to a structural arrangement such as size, shape, material composition, physical construction, logical construction (e.g., programming, operational parameter setting) or other operative arrangement of at least one structure and at least one apparatus facilitating the operation thereof in a defined way (e.g., to carry out a specific function or set of functions).

As used herein, the phrases “connected to” or “connected with” refer to structures operatively connected with each other, such as connected through a direct connection or through an indirect connection (e.g., via another structure or component).

As used herein, the term “electric vehicle” or “EV” refers to a type of automobile powered by one or more electric motors, which derive energy primarily from an onboard rechargeable battery pack. EVs may include battery EVs (e.g., EVs fully powered by batteries with no internal combustion engine (ICE)), plug-in hybrid EVs (PHEVs) (e.g., EVs that combine an electric motor and an ICE with the ability to recharge the battery internally), hybrid EVs (HEVs), fuel cell EVs (FCEVs) (e.g., EVs that use hydrogen fuel cells to generate electricity for the motor instead of storing the electricity in a battery). Additionally, EV may also include autonomous electric vehicles (AEVs).

As used herein, the term “autonomous electric vehicle” or “AEV” refers to is a type of EV equipped with sensor(s), actuators, software systems (e.g., control algorithms, detection software, artificial intelligence models, etc.), and computing systems (e.g., processors) that allow it to navigate and operate without direct human control under certain or all driving conditions. AEVs may include one or more autonomy levels with varying degrees of capabilities. For example, an EV may have level 1 automation (e.g., automation that assists with driving tasks while the driver remains engaged with the EV), level 2 automation (e.g., the EV may autonomously performs certain driving tasks while the driver remains engaged with the EV), level 3 automation (e.g., the EV may autonomously perform all driving tasks under predefined conditions, but the driver must be ready to take control of the vehicle when necessary), level 4 automation (e.g., the EV may operate fully autonomously within geofenced areas or under predefined conditions and no driver intervention is required when the EV operates autonomously), and level 5 automation (e.g., the EV may operate fully autonomously under all conditions without any driver intervention).

As used herein, the term “proximity pilot” refers to a pin on an EV charging port and/or a universal charging connector that detects whether a charging cable configured to interface with the EV charging port is physically connected and securely latched to the EV charging port. Additionally, the proximity pilot pin may communicate the maximum current-carrying capacity of the cable to the EV using a resistor embedded within the cable.

As used herein, the term “control pilot” refers to a pin on an EV charging port and/or a universal charging connector that facilitates bi-directional communication between an EV and an EV charging station. The control pilot pin may use signal modulation (e.g., pulse width modulation) to convey information (e.g., maximum available current from the EV charging station, whether the EV charging station is allowed to charge the EV, whether the EV is available for charging, whether a charging session is in progress, etc.) between the EV and the EV charging station. Additionally, the control pilot pin may enable safety features such as fault detection, load balancing, and power delivery.

The foregoing method descriptions and/or any process flow diagrams are provided merely as illustrative examples and are not intended to require or imply that the steps of the various embodiments must be performed in the order presented. As will be appreciated by one of skill in the art, the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations may be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed here may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to and/or in communication with another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the disclosure. Thus, the operation and behavior of the systems and methods were described without reference to the specific software code being understood that software and control hardware may be designed to implement the systems and methods based on the description here.

When implemented in software, the functions may be stored as one or more instructions or code on a non-transitory computer-readable or processor-readable storage medium. The steps of a method or algorithm disclosed here may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used here, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The previous description is of various preferred embodiments for implementing the disclosure, and the scope of the invention should not necessarily be limited by this description. The scope of the present invention is instead defined by the claims.

What is claimed is:

1. An adapter for connecting an electric vehicle charging station to an electric vehicle, the adapter comprising:
an input connector configured to electromechanically connect to a charging connector of the electric vehicle charging station and receive one or more power signals and one or more data signals from the electric vehicle charging station; and
an output connector in electrical communication with the input connector and configured to electromechanically connect to a universal charging connector that is electromechanically connected to a charging port of the electric vehicle.

2. The adapter according to claim 1, further comprising, a housing, wherein the input connector is formed along a side of the housing.

3. The adapter according to claim 1, wherein the output connector has a different configuration than the charging connector of the electric vehicle charging station.

4. The adapter according to claim 1, further comprising, a converter configured to:
determine whether one or more electric vehicle charging station signals corresponding with the electric vehicle require conversion; and
responsive to determining that the one or more electric vehicle charging station signals require conversion, convert the one or more electric vehicle charging station signals into one or more electric vehicle signals corresponding with the electric vehicle.

5. The adapter according to claim 1, wherein the output connector is formed along a top surface of an autonomous charging system configured to autonomously detect the charging port and electromechanically connect the output connector to the charging port.

6. A system for autonomously detecting a charging port of an electric vehicle comprising:
an actuator;
an object detection system electrically connected to a first end of the actuator, the object detection system configured to locate the charging port;
an input connector electromechanically connected to a second end of the actuator, the input connector configured to receive an electric vehicle charging adapter; and
an output connector electromechanically connected to the first end of the actuator, the output connector configured to electromechanically connect to the charging port.

7. The system according to claim 6, wherein the actuator is a telescopic actuator configured to telescopically extend upward and downward.

8. The system according to claim 7, wherein the telescopic actuator comprises a plurality of bases with a plurality of diameters in a nesting arrangement.

9. The system according to claim 6, further comprising one or more motors mechanically coupled to the actuator and configured to rotate the actuator and linearly displace the actuator.

10. The system according to claim 9, wherein the one or more motors are mechanically coupled to the actuator via one or more belts or one or more rails.

11. The system according to claim 6, further comprising a plurality of inner bases housed within the actuator.

12. The system according to claim 11, wherein the plurality of inner bases interlock as they extend.

13. The system according to claim 6, further comprising a mechanical arm configured to electromechanically connect the output connector to the charging port, the mechanical arm comprising:
a base member;
a first connection member pivotably connected to the base member;
a second connection member pivotably connected to the first connection member;
a third connection member pivotably connected to the second connection member; and
a hinge pivotably connected to the third connection member and connected to the second end of the actuator.

14. The system according to claim 6, wherein the object detection system comprises one or more image processing circuits and one or more distance sensors.

15. The system according to claim 6, wherein the output connector is magnetic.

16. A universal charging connector for an electric vehicle, comprising:
a housing configured to securely fit within an input connector of the electric vehicle;
a first connector connected to a first end of the housing configured to electromechanically connect to the input connector of the electric vehicle used to recharge a rechargeable battery thereof;
a second connector connected to a second end of the housing having a different configuration than the first connector; and
an electrical connector configured to electrically connect the first connector and the second connector, thereby enabling the electric vehicle to receive electrical power and data signals from an electric vehicle charging station.

17. The universal charging connector according to claim 16, further comprising, a converter configured to:
determine whether one or more electric vehicle charging station signals corresponding with the electric vehicle require conversion; and
responsive to determining that the one or more electric vehicle charging station signals require conversion, convert the one or more electric vehicle charging station signals into one or more electric vehicle signals corresponding with the electric vehicle.

18. The universal charging connector according to claim 16, wherein the second connector comprises a plurality of electrically conductive circular electrode regions, each electrically conductive circular electrode region corresponding to a different electrical signal receivable by the electric vehicle.

19. The universal charging connector according to claim 16, wherein the electric vehicle charging station comprises a charging connector with a different configuration than the second connector.

20. The universal charging connector according to claim 16, wherein the second connector is magnetic.
